(19) United States
(12) Patent Application Publication
(10) Pub. No.: US 2014/0067596 A1
(43) Pub. Date: Mar. 6, 2014

(54) METHODS AND APPARATUS FOR RECOMMENDING PRODUCTS AND SERVICES

(71) Applicant: Cobrain Company, Chevy Chase, MD (US)

(72) Inventors: Robert J. McGovern, Chevy Chase, MD (US); John William Schmidt, Falls Church, VA (US)

(73) Assignee: Cobrain Company, Chevy Chase, MD (US)

(21) Appl. No.: 13/774,555

(22) Filed: Feb. 22, 2013

Related U.S. Application Data
(60) Provisional application No. 61/601,664, filed on Feb. 22, 2012.

(51) Int. Cl. G06Q 30/02

(52) U.S. Cl. CPC G06Q 30/0246
USPC 705/26.7

(57) ABSTRACT

A system, method, and apparatus for recommending products and services are disclosed. An example apparatus includes a recommendation engine configured to determine salable items purchased by a consumer, the salable items including salable items purchased from a plurality of merchants and from a plurality of salable item categories and receive a rating from the consumer for each of the purchased salable items. The recommendation engine is also configured to determine cohort consumers from among consumers by selecting consumers who have purchased at least some of the salable items and rated those salable items similar to the ratings provided by the consumer. The recommendation engine determines salable items to recommend for each salable item category by determining recommendable salable items from direct and/or inferential matching based on other salable items purchased by the cohort consumers. The recommendation engine transmits information associated with at least some of the recommendable salable items.

### PRIORITY CLAIM

The present application claims priority to and the benefit of U.S. Provisional Patent Application No. 61/601,664, filed on Feb. 22, 2012, the entirety of which is incorporated herein by reference.

### BACKGROUND

Online product and service advertising currently attempts to target individual consumers by highlighting or recommending certain products and services (e.g., salable items) that are believed to especially appeal to those consumers. Many online merchants spend vast resources collecting consumer purchasing data, analyzing the data to identify purchasing relationships between demographic/geographic characteristics of consumers, and determining which potential consumers should be targeted with advertisements for which products or services. An issue with this demographic/geographic analysis is that consumers with similar demographic/geographic characteristics can have diverse preferences for products and services.

More recently, online merchants and online advertisers recommend products or services based on purchase histories rather than demographic analysis. For instance, online merchants and advertisers use cluster and cohort algorithms and/or product similarity algorithms to recommend products and services to consumers. These algorithms calculate distance vectors between each consumer based on similar purchasing histories or similarities between products. The algorithms determine which products to recommend based on which consumers have the shortest distance vectors and identify similar products purchased among those consumers. Most famously, Amazon® uses algorithms to provide product recommendations that are based on purchase (or browsing) histories of other consumers who have purchased/viewed the same product.

FIG. 1 shows a diagram of a known cluster and cohort algorithm 100 used by merchants. The algorithm 100 provides recommendations to consumers for products only sold by a particular merchant. (e.g., each merchant uses a different algorithm). The illustrated cluster and cohort algorithm 100 provides recommendations based on correlations between products that a consumer has already purchased (or viewed) with other products purchased (or viewed) by other consumers who purchased (or viewed) the same products as the consumer. For instance, the illustrated cluster and cohort algorithm 100 provides a consumer a list of recommended sweaters based on other sweaters purchased by consumers who have also purchased the same sweaters as the consumer.

An issue with the recommendation method provided by the cluster and cohort algorithm 100 is that it only considers purchasing and browsing habits of consumers from the same online merchant. (e.g., Amazon®). Merchants do not share purchasing data with each other. As a result of this limitation, merchant recommendations provided to consumers are limited to only the products or services associated with that merchant. Thus, the same products or services purchased at different online merchants (or at brick and mortar locations of the same merchant) are not considered in the recommendations.

A further limitation is that the algorithms only provide recommendations for salable items within the same category. As shown in FIG. 1, there is no correlation between consumers who have purchased salable items in different product categories. In other words, the algorithm 100 determines separate cohorts for each product category. There accordingly exists a need to provide accurate consumer-specific product/service recommendations based on an aggregation of consumer purchasing and viewing activity from a wide spectrum of unrelated merchants and across different salable item categories.

### SUMMARY

The present disclosure provides a new and innovative system, method, and apparatus for recommending products and services to consumers. A recommendation engine uses one or more cluster and cohort algorithms configured to provide salable item recommendations based on purchase data from different merchants across different salable item categories. The recommendation engine uses collected data to provide, for each category, a list of recommended salable items unique for each consumer. The recommended salable items are products or services that the consumer should most likely enjoy based on purchases, feedback, and preferences from cohorts who have purchased the same products or services or products similar to the same products or services. By being able to provide recommendations for virtually any product or service, the recommendation engine can be queried by a consumer any time the consumer has to make a purchasing decision. In this manner, the recommendation engine becomes a purchasing personal assistant for each consumer.

In an example, the recommendation engine prompts consumers to rate salable items they have previously purchased from different merchants to determine a preference baseline. The recommendation engine uses this information to determine which other consumers (e.g., cohorts) have purchased at least some of the same salable items and rated the salable items substantially the same. For these cohorts, the recommendation engine determines which salable items in each salable item category were most often purchased (and/or highly rated). The recommendation engine then recommends to a consumer that the consumer would most likely enjoy the identified salable items in each category. In providing recommendations, the recommendation engine may also use previous consumer behavior, preferences, demographic/geographic data, and/or salable item meta-data to construct lists of salable items that should be enjoyed by the consumer.

In an example embodiment, a method includes determining that information regarding a salable item associated with a salable item category is to be provided electronically to a consumer device and determining other salable items previously purchased by the consumer, the other salable items each including a rating previously provided by the consumer. The example method also includes determining cohort consumers from among a plurality of consumers by selecting consumers who have purchased at least some of the other salable items and rated those other salable items similar to the ratings provided by the consumer. The method further includes determining recommendable salable items by identifying salable items previously purchased by the cohort consumers that are associated with the salable item category and transmitting to the consumer device the salable item information associated with at least one of the recommendable salable items.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of a known prior art cluster and cohort algorithm used by merchants.

FIG. 2 shows a diagram of an example cluster and cohort algorithm that uses purchase history of consumers across different merchants and different salable item categories to recommend different categories of salable items to individual consumers.

FIG. 3 shows a block diagram of an example recommendation environment for providing salable item recommendations to consumers, according to an example embodiment of the present invention.

FIG. 4 shows an example functional diagram of a recommendation server, according to an example embodiment of the present invention.

FIG. 5 shows a diagram of an example data structure that is created and stored by the recommendation server of FIG. 4.

FIG. 6 shows a diagram of an individual cohort environment determined by the recommendation server of FIGS. 3 and 4.

FIG. 7 shows a diagram of cohort clusters that is displayable to a consumer via a consumer device.

FIGS. 8 and 9 show diagrams of data structures including a list of salable items that the recommendation server of FIGS. 3 and 4 provides to a consumer.

FIG. 10 is a functional block diagram showing electrical systems of an example computing device (e.g., a recommendation server, a consumer device, a third-party server) of FIGS. 3 and 4).

FIG. 11 shows a flow diagram illustrating example procedures to register a consumer with a recommendation service, according to an example embodiment of the present invention.

FIG. 12 shows a diagram of a user interface that enables consumers to provide ratings of previously purchased salable items.

FIGS. 13 and 14 show flow diagrams illustrating example procedures to provide a consumer with salable item recommendations, according to an example embodiment of the present invention.

FIGS. 15 to 19 show diagrams of user interfaces displaying salable item recommendations and information associated with a selected recommended salable item.

FIGS. 20 to 22 show diagrams of different embodiments of salable item recommendations presented to a consumer via a consumer device.

FIGS. 23 to 25 show diagrams of user interfaces that include third-party content displayed in conjunction with recommendations provided by the recommendation server of FIGS. 3, 4, 10, 11, 13, and 14

### DETAILED DESCRIPTION

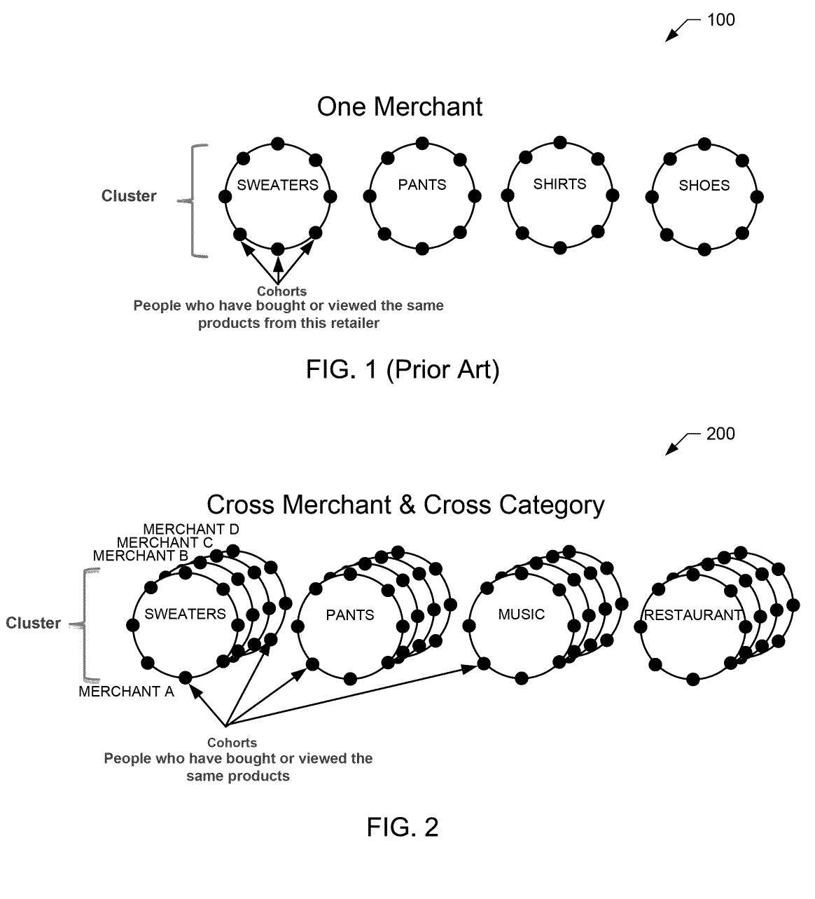

The present disclosure relates in general to a method, system, and apparatus to recommend products and services, and in particular, to using cluster and cohort algorithms to determine which salable items are most likely to be enjoyed by consumers based on previous purchase history of other consumers at the same and different merchants and across salable item categories. FIG. 2 shows a diagram of an example cluster and cohort algorithm 200 that uses purchase history of consumers across different merchants and different salable item categories to provide individual recommendations of salable items to consumers. In contrast to the known algorithm 100 of FIG. 1, the cluster and cohort algorithm 200 of FIG. 2 is configured to receive purchase history from multiple merchants. The algorithm 200 uses this multi-merchant and multi-category data to better correlate consumer purchases. Additionally, the algorithm 200 correlates salable items across categories so that recommendations are based on comprehensively matching cohorts. The known algorithms 100 instead only provide recommendations based on salable items within the same category.

In an example embodiment, a recommendation engine determines for each subscribed consumer one or more lists of recommended salable items for different salable item categories. A consumer may access an application to view the recommended salable items for each category. A consumer may also access the application to search for recommended salable items based on geographic parameters, demographic parameters, pricing, etc.

Further, merchants may use the lists generated for each consumer to provide targeted advertising when a consumer visits a website associated with the merchants or a website with an advertisement purchased by the merchants. In this manner, the merchants are able to incorporate into websites and/or mobile websites salable item recommendations specific for each consumer. This incorporation of the recommendations enables merchants to merchandize particular salable items to specific consumers based on pre-computed recommendations specific for each consumer.

To provide recommendations, a recommendation engine collects consumer purchase history from subscribed consumers. The recommendation engine then uses one or more cluster and cohort algorithms to determine for each consumer which other consumers have similar preferences for salable items. The algorithms correlate purchase history by specific salable items regardless of the merchant that sold the item. The algorithms also correlate purchase history among different salable item categories. The algorithms may also rank, order, and/or filter the recommendations based on previous behaviors and/or preferences of each consumer. These features enable the recommendation engine to provide comprehensive and accurate recommendations for different salable item categories without being limited to one particular merchant or purchases within one salable item category.

In a specific example, a consumer of interest prompts the recommendation engine for a list of recommended dress pants. In response, the recommendation engine identifies cohorts of the consumer. These cohorts are other consumers who have purchased (and rated similarly) the same salable items (or substantially similar salable items) as the consumer of interest. In other words, the cohorts are other consumers who have liked and disliked the same purchased salable items as the consumer of interest. In some examples, the cohorts are consumers who have a shortest distance vector to the consumer of interest based on purchase history (and/or ratings). In some instances, these cohorts may not have purchased the same pairs of dress pants as the consumer of interest. Instead, these cohorts may share similar interests in music, casual pants, restaurants, and casual shirts as the consumer of interest. However, in this instance, the recommendation engine determines that cohorts who share these same salable item preferences also have the same preferences for dress pants. The recommendation engine accordingly determines among these cohorts which brand/type/model of dress pants were purchased most often (and/or most recently). The recommendation engine then provides to the consumer of interest a recommendation list based on the dress pants most often purchased by cohorts. In this manner, the recommendation engine provides accurate, precise, useful recommendations to consumers. Over time, as consumers increase the number of purchases through a recommendations service, the recommendation engine becomes more accurate and precise by having access to additional consumer purchases.

In another example, the recommendation engine uses the cluster and cohort algorithm 200 to provide recommendations for a specific consumer (e.g., a consumer or interest). The recommendation engine provides a recommendation based on the fact that 100 people also like and dislike the same things as the consumer of interest. The recommendation engine determines which other salable items those other consumers have purchased so that a new item may be recommended based on the commonality between the consumer of interest with the 100 other consumers. The recommendation engine may also make inferences when providing recommendations. For example, the recommendation engine may recommend a certain pair of jeans based on commonalities between a consumer of interest and other consumers in clothing, music, and films.

In some examples, the recommendation engine may use previous purchase behavior, preferences, or meta-data (e.g., data that describes a salable item) associated with the consumer to refine the recommendation. In the example above, the recommendation engine may determine that in the past, the consumer has purchased black dress pants more often than other colors of dress pants. The recommendation engine may accordingly provide the recommended dress pants shown in the color black to further align the recommendations to the preferences of the consumer. It should be appreciated that the recommendation engine may also provide similar modifications based on product size. Further, the recommendation engine may select a size/color of a product based on the brand or type of product based on previous purchases and/or trends of cohorts.

Throughout this disclosure, reference is made to a salable item. It should be appreciated that a salable item includes any product, service, or subscription provided by a merchant to a consumer. For example, products can include shoes, clothing, fashion accessories, digital media (e.g., electronically stored music and movies), shows, home appliances, automobiles, personal electronics, audio/video equipment, gaming systems, sporting goods, fragrances, groceries, etc. Service can include restaurant service, hotel service, rental car service, transportation, travel, contractors, photographers, medical services, legal services, professional services, etc. Subscriptions can include subscriptions to digital content (e.g., online magazine/newspaper subscriptions), subscriptions to data feeds, etc.

Further, throughout the disclosure, reference is made to salable item categories. For instance, pants may be partitioned into separate categories of dress pants, casual pants, jeans, workout pants, etc. In another example, restaurants may be included within one category or may be partitioned into separate categories based on restaurant type (e.g., bar, club, diner, gastro-pub, etc.) or food type (e.g., Italian, Indian, Polish, etc.). However, it should be appreciated that such partitioning is only used to illustrate the functionality of the recommendation engine and that in other examples salable items can be partitioned into different types of categories with finer or coarser granularity.

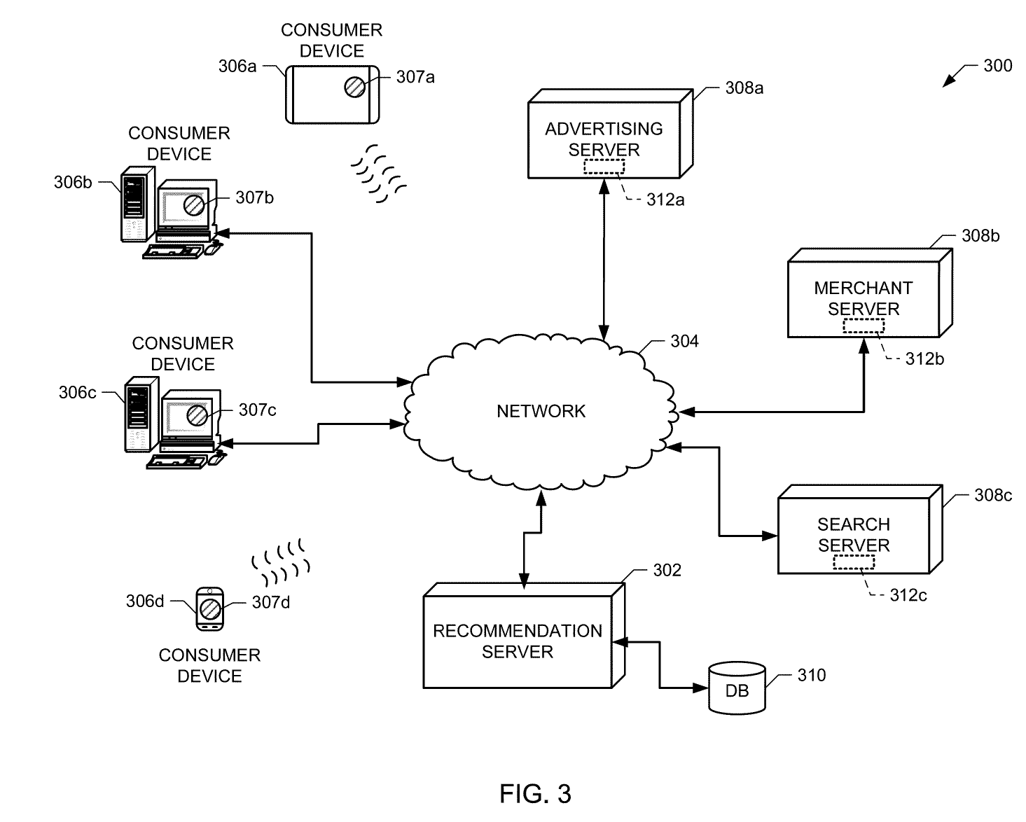

The disclosed system may be readily realized in a recommendation environment 300. A high level block diagram of an example recommendation environment 300 is illustrated in FIG. 3. The illustrated system 300 includes a recommendation server 302 that is connected via a network 304 (e.g., the Internet) to consumer devices 306 and third-party servers 308. It should be appreciated that in other embodiments, the environment 300 can include additional or fewer consumer devices 306 and/or additional or fewer third-party servers 308.

The recommendation server 302 includes one or more processors that compile purchase history and provide recommendations to consumers. The recommendation server 302 manages recommendation data that is displayable by the consumer devices 306. In some instances, the recommendation server 302 provides each of the consumer devices 306 with one or more applications (e.g., apps) 307 that are configured to download and manage lists of recommended salable items. In other instances the recommendation server 302 operates one or more websites that provide lists of recommended salable items to the respective consumer devices 306.

The recommendation server 302 is communicatively coupled to a database 310, which stores data structures of consumer purchase history, salable item consumer ratings, information describing salable items, lists of cohorts for each consumer, demographic/geographic parameters for each consumer, and lists of recommended salable items for each consumer. The database 310 may be implemented by any computer-readable medium, including RAM, ROM, flash memory, magnetic or optical disks, optical memory, or other storage media.

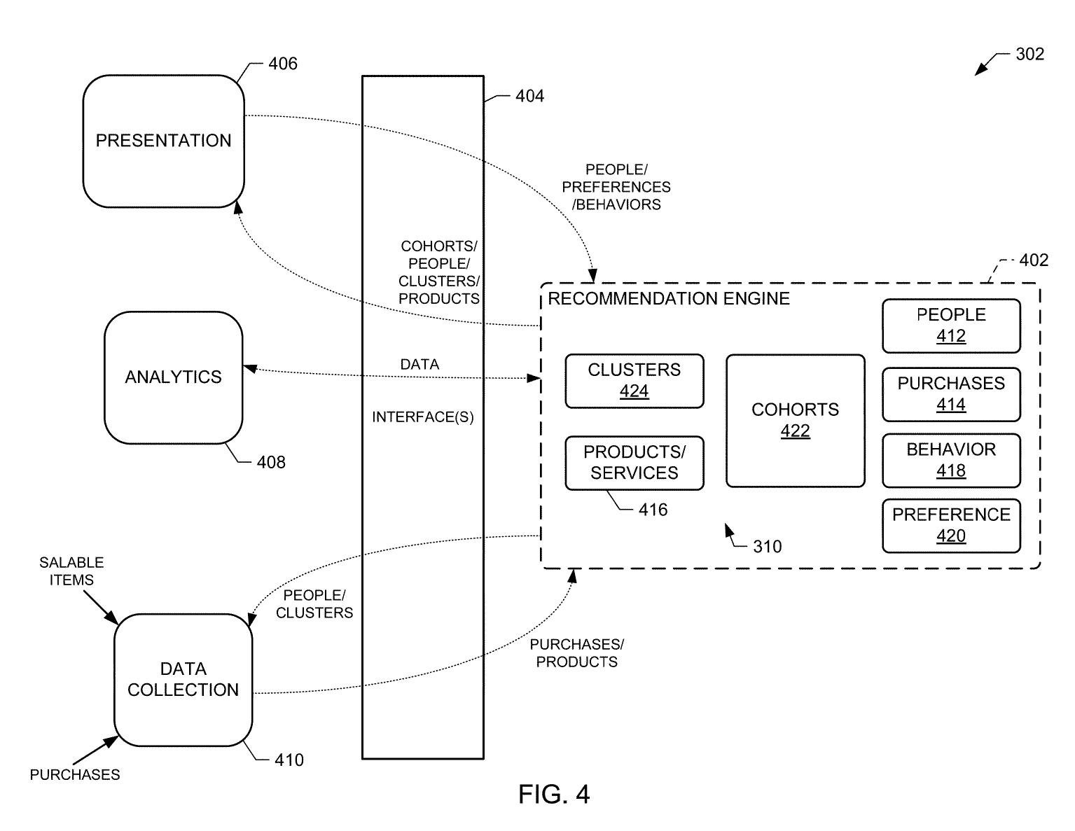

While the recommendation server 302 is shown as a single component, in other embodiments the recommendation server 302 may include multiple servers. Further, the recommendation server 302 may be implemented in a cloud computing framework. Functionality of the recommendation server 302 is described in more detail in conjunction with FIG. 4.

The consumer devices 306 can include any type of computing device that enables consumers to provide purchase histories and view recommended salable items. For instance, the consumer devices 306 can include tablet computers, smartphones, personal computers, laptop computers, servers, processors, gaming consoles, multimedia receivers, etc. The consumer devices 306 may be connected to the network 304 via any wired or wireless connection including, for example, 4G LTE, WiFi, etc.

In this embodiment, the consumer devices 306 each include a recommendation application 307. The consumer devices 306 receive the recommendation application 307 from, for example, the recommendation server 302. For instance, the consumer device 306a registers with the recommendation server 302 causing the server to transmit the recommendation application 307a to the device. In other embodiments, the consumer devices 306 receive the recommendation application 307 from an app store or other entity that enables a consumer to download an application onto their devices.

It should be appreciated that different types of the recommendation application 307 may be transmitted based on the type of consumer device 306. For instance, the tablet consumer device 306a receives an application 307a configured to operate on a tablet while the smartphone consumer device 306d receives an application 307d configured to operate on a smartphone and the personal computer consumer device 306 receives an application 307b configured to operate on a personal computer. In other embodiments, the recommendation application 307 may operate in conjunction with (or be replaced by) a website hosted by the recommendation server 302. In these other embodiments, consumers use the consumer devices 306 to access hosted recommendation webpages to provide purchase history and view recommendations.

The recommendation application 307 provides a graphical interface that enables consumers of the consumer devices 306 to access and view salable item recommendations provided by the recommendation server 302. In some embodiments, the recommendation server 302 periodically transmits recommendations to the recommendation application 307 without a prompt from a consumer. Thus, the recommendation application 307 quickly displays recommendations to a consumer without having to connect to the recommendation server 302. In other embodiments, the recommendation application 307 may only receive recommendations after transmitting a request to the recommendation server 302. In either of the embodiments, the recommendation application 307 manages how information describing the recommended salable items is presented to consumers.

The recommendation application 307 may also operate in the background of the consumer devices 306 to collect purchase information. For example, the recommendation application 307 may monitor consumer accounts or website usage to determine which salable items a consumer purchases and report these purchases to the recommendation server 302. The recommendation application 307 may also collect feedback data regarding which recommended salable items a user views and/or purchases. The recommendation application 307 may also provide third-party servers 308 with identities of consumers and/or recommendations so that the servers can display consumer-specific recommendations when consumers visit websites hosted by the third-parties. For instance, a consumer uses a web browsing application on the consumer device 306a to access the merchant server 308b to browse athletic shoes. The recommendation application 307a transmits an identity of the consumer (and/or salable item recommendations associated with that particular merchant) to the merchant server 308b. The merchant server 308b then displays advertisements on one or more webpages for salable items corresponding to the recommended salable items provided to the merchant.

The third-party servers 308 include any processor that hosts a third-party program or website that is operated by, for example, a merchant, an advertiser, a search engine entity, a salable item manufacturer, etc. The thirty-party servers 308 may be implemented by individual servers and/or by multiple servers in a cloud computing environment. As disclosed herein, the third-party servers 308 use recommendation data provided by the recommendation server 302 to display recommendations to consumers.

For example, the third-party servers 308 include recommendation components 312 that interface with the recommendation server 302. The recommendation components 312 may be a software program implemented at the servers 308 or, alternatively, an application programmable interface (“API”) that enables the recommendation server 302 provide recommendation data. The recommendation components 312 provide functionality that enables the third-party servers 308 to receive recommendations for different consumers.

For instance, the advertising server 308 may be operated by an entity that manages advertising space on websites. A merchant instructs the entity to use recommendation data within an advertisement space purchased by the merchant. Thus, when consumer device 306a connects to a website with the advertisement space, the advertising server 308a identifies which consumer is accessing the website using a cookie or other identifier stored within the device 306a. The advertising server 308a identifies a list of recommended salable items associated with the identified consumer and selects one of the salable items associated with the merchant who purchased the space. In this manner, the advertising server 308a increases the number of times consumers select advertisements by providing to the consumers salable items they are most likely to enjoy.

In another example, the merchant server 308b requests from the recommendation server 302 lists of recommendations for consumers. The lists may only include salable items sold by the merchant or salable items sold by all merchants. The merchant server 308b then monitors which consumers visit a website operated by the merchant. The merchant server 308b, operating in conjunction with the recommendation component 312, determines which lists correspond to the consumer and accordingly selects one or more salable items to place in an advertisement displayed in conjunction with the merchant website. In this manner, the merchant server 308b provides advertisements for salable items that are more likely to be purchased by consumers.

In yet another example, the search server 308c requests from the recommendation server 302 lists of recommendations for consumers. The search server 308c uses the lists to display links or advertisements for salable items included within the lists for the respective consumers based on searches performed by the consumers. For instance, a consumer may provide the search term “dress pants” into a search engine. In response, the recommendation component 312 of the search server 308c identifies the consumer (via cookies embedded within the consumer device 306), determines which lists correspond to the consumer, and selects salable items from the lists that correspond to the term “dress pants.” The salable items may be displayed as merchant sponsored links at the top of the search results or as advertisements displayed in conjunction with the search results. In addition to textual searches, one can appreciate that a map program operated by the search server 308c provides locations of recommended salable items in response to a map-based search.

### Recommendation Server

FIG. 4 shows an example functional diagram of the recommendation server 302 of FIG. 3. It should be appreciated that the diagram shown in FIG. 4 is only one example of implementing the recommendation server 302. In other embodiments, the functional blocks may be combined, removed, rearranged or expanded. For instance, the recommendation server 302 may additionally include a data mining component.

The illustrated recommendation server 302 includes a recommendation engine 402, an interface 404, a presentation component 406, an analytics component 408, and a data collection component 410. The recommendation engine 402 provides cross-merchant sales item recommendations to consumers based on cross-category sales item purchases by identified cohorts. The recommendation engine 402 includes the following functionality: i) data gathering, ii) consumer analysis, iii) cohorts identification, iv) salable item recommendation determination, v) recommendation publication, and vi) feedback.

The recommendation engine 402 may be implemented in conjunction with the interface 404 and the components 406-410 within a cloud computing environment. The components 406-410 may be externally facing processors that enable third-parties and consumers to interact with the information provided by the recommendation engine 402. The interface 404 can include firewalls and other security features to restrict access so that only authorized information may be transmitted and received with the recommendation engine 402. The interface 404 may include one or more APIs to enable third-parties or consumers to securely access information managed and stored by the recommendation engine 402. In other embodiments, the interface 404 may be combined with the components 406-410 and/or the recommendation engine 402.

### i) Data Gathering

The recommendation engine 402 uses the data collection component 410 to receive consumer purchase history and ratings. The recommendation engine 402 also uses the data collection component 410 to receive descriptions of sales items that can be recommended to consumers. The recommendation engine 402 prompts consumers to provide purchase history by specifying an account of the consumer that includes records of salable item purchases.

For instance, a consumer may provide the recommendation engine 402 access to an e-mail account through the data collection component 410. The recommendation engine 402 scans through the e-mails in search of receipts. For each receipt, the recommendation engine 402 extracts sales data including, identifiers of sales items purchased (e.g., stock-keeping units (“SKUs”)), price paid for each sales item, and any meta-data that describes the salable items. The recommendation engine 402 may reference identifiers of salable items purchased to one or more data structures that include more detailed descriptions of the corresponding salable items. Merchants or product manufacturers provide the detailed descriptions (including SKU numbers) for the salable items. The recommendation engine 402 creates a data structure to store the extracted and identified purchase data.

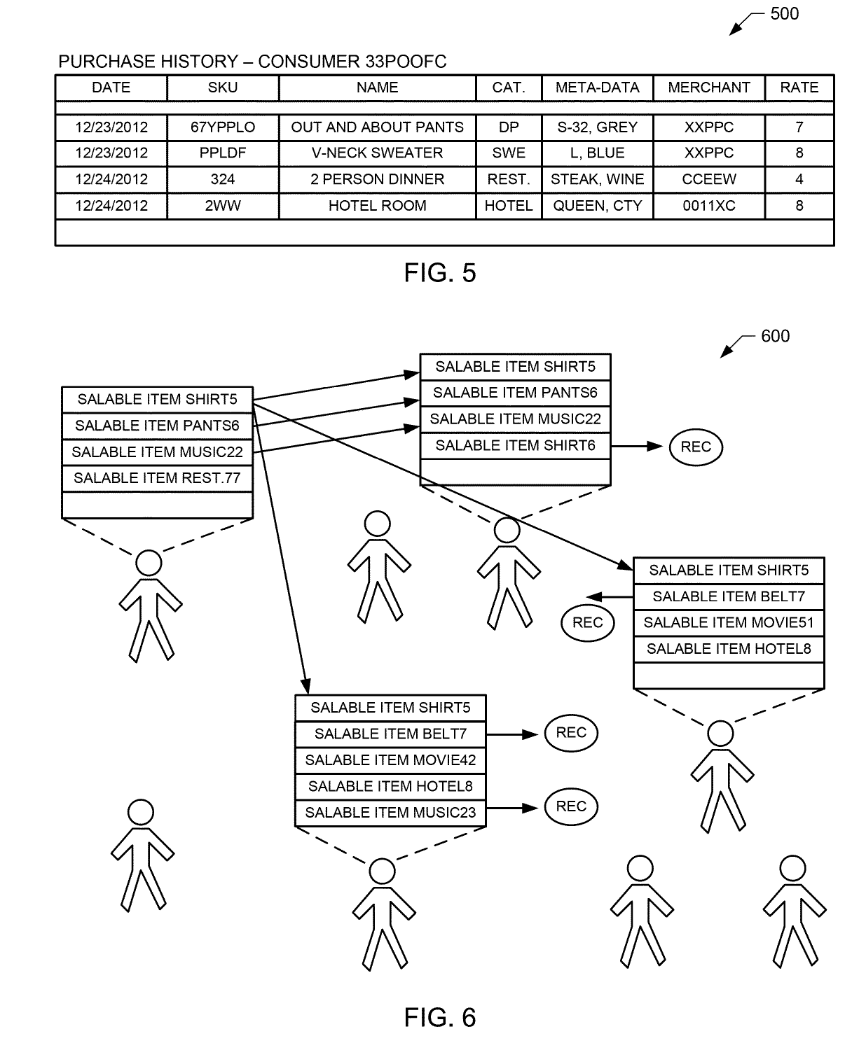

FIG. 5 shows a diagram of an example data structure 500 that is created and stored by the recommendation engine 402. The illustrated data structure 500 includes data fields for a date of purchase, a salable item identifier (e.g., SKU), a name of the salable item purchased, a category assigned to the salable item, meta-data associated with the salable item, a merchant that sold the salable item, and a rating provided by the consumer. It should be appreciated that in other embodiments the data structure 500 can include additional or fewer data fields. Further, in other embodiments, the data structure 500 may be partitioned into separate data structures (e.g., a data structure for previous purchases, a data structure for meta-data, and a data structure for ratings).

Returning to FIG. 4, in another embodiment, a consumer may provide the recommendation engine 402 with access to a credit card account to provide purchase history information. The recommendation engine 402 scans the credit card records for purchases of salable items and extracts purchase history data in the same manner as described above in conjunction with an e-mail account. In yet further embodiments, a consumer may manually provide salable item purchase history.

In some embodiments, after a consumer has provided purchase history, the recommendation engine 402 may periodically access a consumer's e-mail or credit card account to scan for more recent purchases. This periodic updating ensures that a consumer's most recent purchases are considered when the recommendation engine 402 provides recommendations. The periodic updating may occur daily, weekly, monthly, etc.

Alternatively, a consumer may grant a merchant permission to provide purchase history. For instance, during initial registration with the recommendation server 302, a consumer may specify which merchants are authorized to provide purchase history for that consumer. In response, the recommendation engine 402 requests the consumer's purchase history from the specified merchants. The merchants can provide any purchases by the consumer online and/or at brick and mortar stores.

The recommendation engine 402 stores the profile information of each consumer into a people section 412 of the database 310. The recommendation engine 402 stores the purchase history of each consumer to a purchases section 414 of the database 310. In some embodiments, the sections 412 and 414 may be combined into a single data structure for each consumer.

In addition to obtaining consumer purchase history, the example data collection component 410 also obtains salable item information from merchants (e.g., from the merchant server 308b). In some embodiments, merchants access an API of the data collection component 410 and provide information on salable items that the merchant is offering for sale. In some instances, the data collection component 410 may be included within a group of destinations that receive published salable items (and items that are no longer available) from merchants. The merchants may publish salable items hourly, daily, weekly, etc. The salable item information includes, for example, graphical representations of salable items (e.g., pictures), prices of the salable items, quantities of the salable items, sizes/colors and descriptions of the salable items (e.g., meta-data), dates for which the salable items are available, identifiers of the salable items, links to the salable items on websites operated by the merchant, and/or any story or narrative associated with the salable item.

As an alternative to receiving publications from merchants, the data collection component 410 may receive one or more private feeds or transmissions from a merchant. These private feeds may provide salable item information that is unique to the service provided by the recommendation server 302. In some embodiments, the merchants may use the private feeds to specify that certain products are to be offered to consumers who meet certain criteria and/or to specify certain pricing conditions.

For instance, a merchant may use a private feed to the data collection component 410 to provide information regarding a medium orange shirt. The merchant may specify that the recommendation server 302 is to include the medium orange shirt into recommendation calculations for consumers who have previously purchased similar orange shirts from the merchant. Thus, while a merchant can provide private limitations on salable items, the merchant cannot influence as to whether the salable items are recommended to consumers or an order at which the salable items appears in the recommendations.

Regarding pricing, a merchant may specify via a private feed to the data collection component 410 how the recommendation server 302 is to price a salable item based on where the salable item appears on a recommendation list. For instance, a merchant may indicate that a price for a type of dress pants is to be $45 if the pants are lower than fourth on a recommendation list, $55 if the pants are lower than second on a recommendation list, and $65 if the pants are first on a recommendation list. This enables a merchant to provide incentives for a consumer to select a relatively lower recommended salable item without directly influencing the recommendation rank.

In addition to information regarding purchased salable items, the merchants can also indicate whether the purchases were made online, in-store, and/or through a third-party. Moreover, third-party processors can provide purchase histories. For instance, an online travel company provides hotel, rental car, and airline reservation information.

As discussed, the example recommendation engine 402 receives purchase history from merchants and third-parties through the data collection component 410. The data collection component 410 is configured to receive structured data feeds of purchase history from, for example, an API. Each merchant or third-party may provide the purchase history through one or more data feeds. Alternatively, the recommendation engine 402 periodically requests the purchase history. In yet other embodiments, the third-party processor or merchant may transmit the purchase history in a data structure such as, for example, an e-mail.

In addition to receiving salable item information from merchants, the data collection component 410 may also scour or scan websites for available salable items. In this embodiment, the data collection component 410 is configured to acquire salable item information based on information scanned on a webpage. In yet another embodiment, consumers may provide salable item information. For instance, a consumer may submit salable item information or, alternatively, the data collection component 410 may acquire salable item information while reading an account that includes a consumer's purchase history.

The recommendation engine 402 of FIG. 4 stores the salable item information to a products/services section 416 of the database 310. The recommendation engine 402 may store the salable items by category, merchant, etc. Further, the recommendation engine 402 may remove salable items from the section 412 in response to a published list or private feed from a merchant indicating that a salable item is no longer available.

### ii) Consumer Analysis

Using data stored in the people section 412 and the purchases section 414, the example recommendation engine 402 of FIG. 4 determines behavior and preference properties for each consumer. Determining these properties enables the recommendation engine 402 to refine recommendations based on known consumer preferences and shopping behaviors. The recommendation engine 402 stores the behavior properties to a behavior section 418 and preference properties to a preference section 420. The recommendation engine 402 initially determines consumer preference and behavior properties upon a consumer registering for the recommendation service. Thereafter, the recommendation engine 402 may periodically amend the behaviors and preferences as the consumer purchases more salable items and/or as the recommendation engine 402 identifies cohorts associated with the consumer. The recommendation engine 402 may further amend consumer behaviors and preferences after determining changes to preferences and behaviors of cohorts.

To determine a behavior of a particular consumer, the recommendation engine 402 analyzes previous purchases of that consumer to identify purchase patterns. A consumer's behavior includes any inferences that describe when and how a consumer purchases a salable item. For instance, the recommendation engine 402 may determine that a consumer makes purchases for some types of salable items (e.g., dress pants) on weekends and purchases for other types of salable items (tee-shirts) during week days. The recommendation engine 402 accordingly stores this identified behavior to the behavior section 418 such that salable items can be recommended to the consumer that match or correlate to when the consumer usually makes similar purchases (e.g., recommend dress pants during weekends).

Other types of behaviors can include identifying which salable items are purchased online compared to items purchased in physical stores and/or which types of salable items are typically purchased together (e.g., dress shirts and dress pants). Behaviors can further include identifying whether a consumer purchases salable items from the same category from a few (or many) merchants, an average price spent per type of salable item, which geographic locations correspond to different categories of purchased salable items, and/or approximate amounts of money spent for salable items.

Similar to behavior, the recommendation engine 402 also uses past purchases to identify consumer preferences. A consumer's preferences correspond to correlations among certain traits of salable items. For instance, the recommendation engine 402 determines a consumer's preference for size, color, brand, merchant, type of salable item, etc. The recommendation engine 402 uses the preferences to refine recommendations so that displayed salable items correspond to previous preferences of the consumer. For instance, the recommendation engine 402 determines that a consumer has a preference for size 32-regular jeans from Merchant A. In response to having access to this preference, the recommendation engine 402 is able to recommend only pairs of jeans that are available in size 32-regular.

Further, the recommendation engine 402 correlates the preference data of a consumer of interest to preference data of other consumers to extrapolate that consumer's preferences of salable items not yet purchased by the consumer. In the example described above, the recommendation engine 402 may determine that a pair of jeans from Merchant B is to be highly recommended for a consumer. The recommendation engine 402 also determines that other consumers who have purchased size 32-regular jeans from Merchant A typically purchase size 28-tall jeans from Merchant B. The recommendation engine 402 accordingly provides a recommendation for the jeans from Merchant B in the 28-tall size. In this manner, the recommendation engine 402 uses purchase history of other consumers to provide sizing correlations between different brands, merchants, and/or types of salable items.

### iii) Cohort Identification

The example recommendation engine 402 of FIG. 4 provides recommendations to consumers based on purchases of cohorts. To identify cohorts, the recommendation engine 402 determines for each consumer, other consumers who have purchased similar items. The recommendation engine 402 determines cohorts for each salable item category for each consumer to create groups of cohorts (e.g., pseudo groups, clusters, or LikeMe groups).

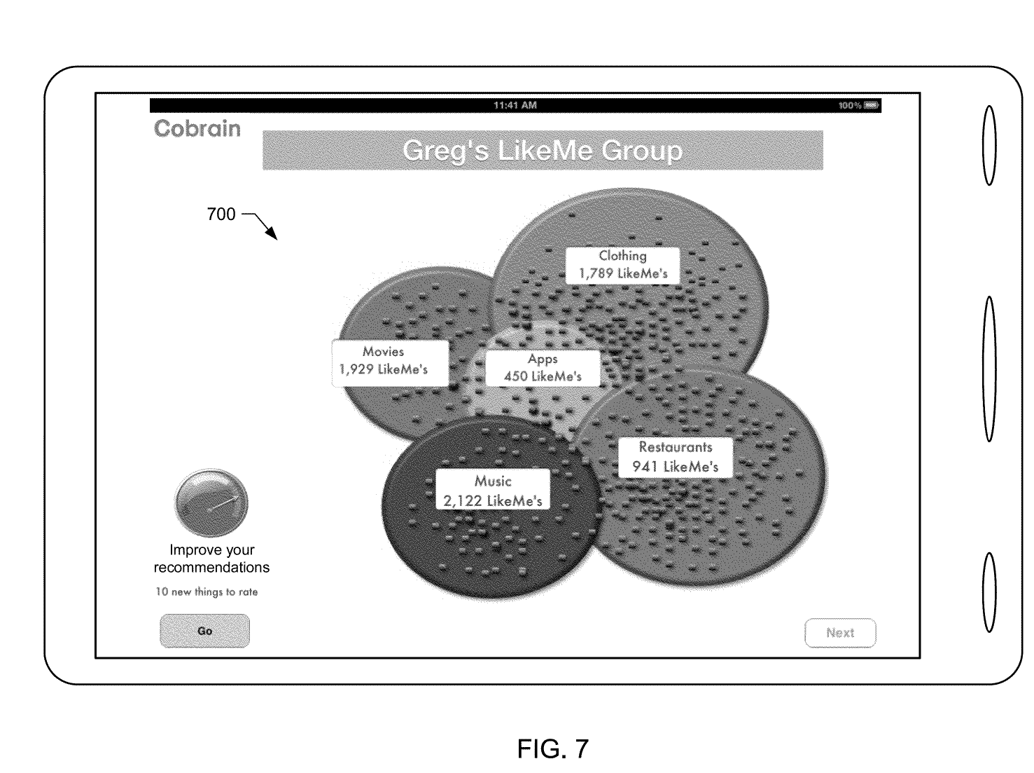

FIGS. 6 and 7 show diagrams of graphical representations of the calculations performed by the recommendation engine 402 to identify cohorts. In particular, FIG. 6 shows a diagram of an individual cohort environment 600. For a consumer of interest 602, the recommendation engine 402 uses one or more cohort and cluster algorithms to determine distance vectors with other consumers. The distance vector calculation is based at least on how many salable items the consumers have in common with the consumer of interest 602. The distance vector calculation may also include a factor that considers the similarity of ratings for the shared salable items. The recommendation engine 402 uses the distance vectors to determine a numerical confidence score for selecting recommendable salable items.

For instance, the recommendation engine 402 determines that for the shirt category the consumer of interest 602 has relatively short distance vectors with consumers 604, 606, and 608 because these consumers all purchased similar shirts (e.g., Shirt5). The recommendation engine 402 accordingly designates consumers 604, 606, and 608 as cohorts for the shirt group or cluster. The recommendation engine 402 may adjust the distance vectors for each consumer 604, 606 and 608 based on the similarity of ratings of commonly purchased salable items. For example, the recommendation engine 402 may shorten the distance vector with consumer 606 because that consumer and the consumer of interest 602 both rated Shirt5 as a 9. Similarly, the recommendation engine 402 may lengthen the distance vector with consumer 608 because the consumer rated the Shirt5 as a 3.

In addition to determining cohorts for the shirt category, the recommendation engine 402 identifies cohorts for other salable item categories. In the example of FIG. 6, the recommendation engine 402 determines that consumer 604 has a relative short distance vector to the consumer of interest 602 for pants and music. The recommendation engine 402 accordingly designates the consumer 604 as a cohort of the consumer of interest 602 for the pants category and the music category.

In an example, the recommendation engine 402 creates a cohort group (or cluster) for each salable item category that includes consumers who purchased the same salable items in each category as a consumer of interest 602 who rated the salable items with a score of 8, 9, or 10. If the sample set becomes too large, the recommendation engine 402 may stop considering lower rated salable items. If the sample set becomes larger than the recommendation engine 402 selects some preset size X, for example, 100, as a cohort sample set for a consumer of interest 602. The recommendation engine 402 may reduce a number of cohorts within a group by also factoring the highest scoring cohorts who also match the dislikes of the consumer of interest 602. This enables the recommendation engine 402 to provide recommendations by finding the consumers who love and hate the same things as the consumer of interest 602.

In some embodiments, the recommendation engine 402 selects cohorts by matching biographic information to a consumer of interest. The recommendation engine 402 may use relatively broad ranges during computation. For example, divisions in age may range by decade, with people in their 20's grouped together, people in their 30's grouped together, and so on.

FIG. 7 shows a diagram of cohort clusters 700 that is displayable to a consumer via the consumer device 306. The cohort clusters 700 are a graphical representation of a number of cohorts for the consumer of interest 602 in each salable item category. It should be appreciated that one cohort can be included in multiple categories. It should also be appreciated that the diagram of FIG. 7 is only one example of cohort clusters. It should further be appreciated that the cohort clusters will be different for each consumer.

In other embodiments, the recommendation engine 402 may provide a graphical representation with more salable item categories or less salable item categories. In some embodiments, the consumer of interest 602 may select an individual cohort from the cohort clusters 700 to view, for example, a purchase history of that cohort and/or a profile or preferences of that cohort. In some examples, cohorts may provide an indication as to which other consumers have access to view purchase history. For instance, a group of friends may indicate that each friend in the group can view the profile and purchase history of the other friends. In another example, a celebrity may make their purchase history and/or profile publicly available. In these instances, the recommendation engine 402 may visually highlight celebrity or friend cohorts within the cohort clusters 700.

After determining cohorts for a consumer of interest 602, the example recommendation engine 402 stores a list of these cohorts (and their respective purchase histories) to a cohort section 422 of the database 310. The recommendation engine 402 also stores to which salable item category each cohort is included within a cluster section 424. The recommendation engine 402 determines cohorts for each consumer on a periodic basis. For example, the recommendation engine 402 may modify daily which consumers are cohorts for a particular consumer based on the most recent purchases. Storing cohorts and cluster information enables the recommendation engine 402 to relatively quickly provide salable item recommendations because once cohorts are identified, relatively less processing is used to identify salable items.

### iv) Salable Item Recommendations

The recommendation engine 402 of FIG. 4 uses the information stored to the sections 412-424 to generate unique salable item recommendations for each consumer. To provide salable item recommendations, the recommendation engine 402 uses one or more cluster and cohort algorithms to determine which salable items are most likely to be enjoyed and/or purchased by a particular consumer. In other words, the recommendation engine 402 uses the information stored within the sections 422 and 424 to determine recommended salable items. For each salable item category, the recommendation engine 402 determines cohorts associated with the salable item category for the certain consumer of interest 602. This is referred to herein as direct matching. The recommendation engine 402 also uses inferential matching to determine recommendations based on cross-category correlations between salable items.

For direct matching, the recommendation engine 402 determines salable items within the same category that were purchased (and rated relatively highly) by the cohorts but not purchased by the consumer of interest 602. For example, to provide a recommendation for shirts, the recommendation engine 402 determines that the cohort 604 in FIG. 6 purchased Shirt6. The recommendation engine 402 determines among the cohorts which shirts were most frequently purchased (and/or highly rated). The recommendation engine 402 then creates a list of those most purchased shirts for recommendations in the shirt category for the consumer of interest 602.

For inferential matching, the recommendation engine 402 determines correlations across salable item categories among cohorts. Inferential matching enables the recommendation engine 402 to provide more accurate recommendations by identifying salable items that have been purchased by like-minded consumers. For example, in FIG. 6 the recommendation engine 402 determines that among the cohorts 604, 606, and 608 who purchased Shirt5, they also purchased Belt7. For the belt category, the recommendation engine 402 accordingly recommends Belt7 for the consumer of interest 602 despite the fact that the consumer 602 has no previous purchase of belts that match the cohorts 604, 606, and 608.

It should be appreciated that FIG. 6 shows a relatively simple example of inferential matching. The example recommendation engine 402 disclosed herein uses cluster and cohort algorithms that are configured to determine correlations across numerous salable item categories among hundreds to thousands of cohorts. This correlation is relatively dynamic because different consumers have different levels of correlation with other consumers. For instance, the recommendation engine 402 may determine that music, dress pants, sweaters, restaurants, hotels, and golf equipment have a correlation with one group of cohorts and sports equipment, alcoholic beverages, sporting events, and jeans have a correlation with another group of cohorts. Further, as cohorts purchase additional salable items, the correlations may change to reflect the most recent purchases and/or trends.

In an example, the recommendation engine 402 determines that for a consumer of interest 602, there is a correlation among cohorts between jeans, music, shirts, movies, and restaurants. The recommendation engine 402 accordingly performs inferential matching to determine that the consumer of interest 602 has purchased very little of the same music and movies as other cohorts. However, the recommendation engine 402 determines that based on the correlation between jeans, music, shorts, movies and restaurants, the consumer of interest 602 may enjoy some of the same movies and music purchased by other cohorts because the consumer of interest 602 enjoyed the same jeans and shirts as those other cohorts. In this manner, the recommendation engine 402 is able to provide relatively more sophisticated and accurate recommendations based not only on direct matches but also inferential matches across salable item categories.

The recommendation engine 402 of FIG. 4 determines which salable items are recommendable based on a confidence score calculated for each salable item. The confidence score is a numerical value of how likely a consumer of interest would enjoy or love a salable item. The confidence score may be based on, for example, a weighted average of distance vectors between the consumer of interest 602 and associated cohorts, a number of cohorts who purchased the same salable item, a weighted average of how recently different cohorts purchased the same salable item (e.g., trending), and/or whether the salable item was selected via direct or inferential matching (where direct matching may receive a higher score).

The recommendation engine 402 selects recommendable salable items for each category that exceed a predetermined confidence score. In other embodiments, the recommendation engine 402 selects a predetermined number of the top scoring salable items. For instance, the recommendation engine 402 provides a consumer the highest scoring recommendable salable items as recommended salable items. The recommendation engine 402 orders/ranks the salable items by presenting the salable items with the greatest confidence score first followed by the next highest scoring salable item, etc.

In addition to determining salable item recommendations based on purchases of cohorts, the recommendation engine 402 also uses preferences and behaviors (and/or salable item meta-data) of the consumer of interest 602 to recommend salable items. The recommendation engine 402 may adjust confidence scores for the salable items based on the preferences and behavior. Additionally or alternatively, the recommendation engine 402 may be configured to select additional salable items based on the preferences and behaviors and determine who these salable items compare to through cohort analysis.

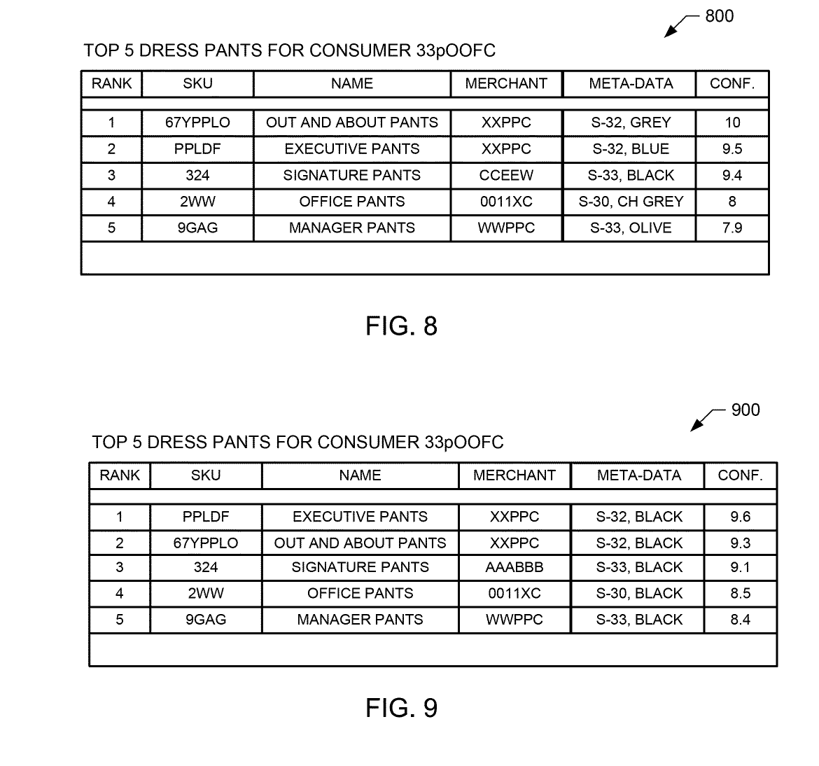

For example, FIGS. 8 and 9 show diagrams of data structures 800 and 900 that include a list of dress pants that the recommendation engine 402 provides to a consumer of interest 602. The data structure 800 in FIG. 8 corresponds to recommendations based on direct and inferential cohort matching. In this example, the recommendation engine 402 selects a color and size for each pair of dress pants based on colors purchased by cohorts and relative sizing between the consumer of interest 602 and cohorts based on brand, merchant, and/or style. The ‘Conf.’ data field shows a calculated confidence score for each type of recommended dress pants, which is used by the recommendation engine 402 to create an ordering within the data structure 800.

FIG. 9 shows the data structure 900 of FIG. 8 amended based on the recommendation engine 402 applying preferences and behaviors of the consumer of interest 602. For instance, the recommendation engine 402 determines from previous purchases that the consumer prefers the ‘Out and About’ dress pants less (based on ratings of previous pairs of similar pants) and accordingly reduces the confidence score. This adjustment causes the position of the ‘Out and About’ dress pants to drop to the second rank. Additionally, the recommendation engine 402 determines that the consumer of interest 602 only purchases black dress pants based on meta-data associated with previous dress pants purchases. Accordingly, the recommendation engine 402 specifies that each of the five ranked types of dress pants are to be shown to the consumer of interest 602 in the color of black.

It should also be noted that the recommendation engine 402 changes which merchant is to be shown in conjunction with the ‘Signature Pants.’ During the cohort analysis, the recommendation engine 402 determined that the cohorts preferred to purchase the ‘Signature Pants’ at merchant ‘CCEEW.’ However, after analyzing the preferences of the consumer of interest 602, the recommendation engine 402 determines that the consumer prefers to purchase dress pants from merchant ‘AAABBB.’ The recommendation engine 402 determines that the same ‘Signature Pants’ are sold by merchant ‘AAABBB’ and accordingly changes which merchant is displayed as selling the ‘Signature Pants.’

It should be appreciated that the examples described in conjunction with FIG. 9 are only a few ways the recommendation engine 402 may use behavior and preferences properties of a consumer to provide recommendations. In other embodiments, the recommendation engine 402 uses meta-data associated with previous purchases of the consumer to determine purchasing trends. For instance, the recommendation engine 402 may note that from previous dinner bills (or meta-data descriptions of a restaurant), at least one menu item includes a vegan dish (or the restaurant had many vegan dishes). The recommendation engine 402 uses this information to adjust restaurant recommendations to include restaurants that have vegan dishes.

It should further be appreciated that the recommendation engine 402 provides more accurate recommendations as a consumer reports and rates additional purchases. The recommendation engine 402 determines more distance vectors to cohorts based on having access to greater numbers of salable items purchases by a consumer. Additionally, more salable items enables the recommendation engine 402 to perform more accurate inferential matching across salable item categories and perform more accurate correlations based on meta-data, preferences, and behaviors. Thus, the more a consumer uses the recommendation system provided by the recommendation server 302, the more accurate the recommendation engine 402 becomes for providing recommendations.

For example, on the first day of using a recommendation service, the recommendation engine 402 selects few cohorts for a consumer of interest that have matching ratings for a small number of common purchases. As the number of consumers of the recommendation service increases, more and more consumers with higher scores may be included as cohorts. This enables the recommendation engine 402 to remove cohorts that rated salable items more differently than the consumer of interest. Thus, the recommendation engine 402 provides more accurate recommendations based on a larger pool of consumers with similar purchases and ratings.

The recommendation engine 402 may recommend different salable items to a consumer as the consumer changes. For example, a consumer may gain weight. As the consumer starts buying different clothes (or different sized clothes), the recommendation engine 402 identifies cohorts who have purchased similar clothes and provides recommendations based on the more recently purchased clothes.

It should also be appreciated that the recommendation engine 402 is configured to determine confidence scores not only on which salable items were purchased by cohorts but also which salable items were viewed and/or rated by cohorts. For instance, the recommendation engine 402 uses a first weight if a salable item was only viewed by a cohort, a second weight if the salable item was purchased by the cohort, and a third weight if the salable item was highly rated by the cohort. In this instance, the second weight is greater than the first weight and the third weight is greater than the second weight. The recommendation engine 402 accordingly updates or amends a confidence score after detecting that a cohort has changed a relationship with a salable item (e.g., view to purchase or purchase to rate). The recommendation engine 402 may also update confidence scores based on actions performed by a consumer of interest (e.g., view, purchase, rate, etc.). In this manner, the recommendation engine 402 uses consumer and/or cohort actions in relation to salable items to determine, at least in part, the confidence score.

The example recommendation engine 402 also may be configured to select which salable items are recommended based on dynamic information provided by a merchant. For example, the recommendation engine 402 provides recommendations regardless of an available of a salable item (e.g., static information). However, a merchant may indicate that certain (or all) salable items are subject to inventory requirements or salable item availability (e.g., dynamic information). In these instances, the recommendation engine 402 may filter recommendations for salable items that are no longer available. In some embodiments, the merchants may specify when a salable item is not available. In other embodiments, the merchants may specify a certain number of available saleable items. In these other embodiments, the recommendation engine 402 monitors how many of these limited salable items are sold and removes the salable item from recommendations after reaching the certain number.

### v) Publishing Recommendations

The example recommendation engine 402 of FIG. 4 transmits the recommendations (e.g., the data structures 800 or 900) to a consumer device 306 via the presentation component 406. The recommendation engine 402 is configured to provide recommendations in response to request messages. The recommendation engine 402 is also configured to publish recommendations. For example, the recommendation engine 402 may publish recommendations to a recommendation application 307 operating on a consumer device 306. Thus, when the consumer uses the device 306, the recommendations are already locally stored and can be displayed relatively quickly. Further, the recommendation engine 402 may transmit recommendations via an e-mail, text message, push notification, and/or any other type of synchronous/asynchronous communication medium to the appropriate consumers.

In another example, the recommendation engine 402 may be configured to publish lists of recommended salable items for each consumer to the third-party servers 308. The third-party servers 308 use the consumer-specific recommendations in advertisements displayed to the appropriate consumers. The advertisements may be displayed in webpages, applications, direct communications (e.g., e-mail, catalogs, solicitations, etc.), etc.

Alternatively, the recommendation engine 402 may determine recommendations in response to requests from the consumer devices 306 or the third party servers 308. Regarding the consumer device 306, the recommendation engine 402 receives a request for salable item recommendations regarding a specific category. In response, the recommendation engine 402 determines a list of recommended salable items for that category and transmits the list to the consumer device for display by the recommendation application 307. Regarding third-party servers 308, the recommendation engine 402 receives a request for a list of recommendations for a particular consumer (identified using embedded cookies). The request may also indicate a particular merchant and/or a particular salable item category. In response, the recommendation engine 402 determines recommended salable items that match the provided criteria and transmits those recommendations to the third-party server 308.

Transmitting recommendations includes transmitting for each salable item category a certain number (e.g., top 5, 10, 15, etc.) of salable items. It should be appreciated that the salable items are not themselves transmitted but instead, graphical representations of the salable items, salable item identifiers, pricing information, and any other information that was provided by the respective merchant and stored to the products/services section 416. In some examples, the recommendation engine 402 may only transmit some salable item information to display the recommended salable items within a graphical list. A consumer may select one of the salable items causing the recommendation engine 402 to transmit additional information associated with the selected item.

The recommendation engine 402 (or recommendation application 307) may use a sequencer to provide a consumer of interest new sets of recommended salable items, which may be selected from all of the items that would be rated higher than an 8, 9 or 10, that the consumer has not already purchased. The salable items may be shown in rotation, starting, with highest scored items shown first. The shown salable items may be rotated on a set interval, such as, for example, one per week, or may be rotated at any other time.

### vi) Feedback

In addition to providing recommendations, the example recommendation engine 402 of FIG. 4 refines its operation through the analytics component 408. The recommendation engine 402 may use the analytics component 408 to monitor which recommended salable items are viewed and/or purchased by the consumer. The recommendation engine 402 may update preference or behavior information in the sections 418 and 420 in response to this monitoring. For instance, the recommendation engine 402 determines that a consumer purchased dress pants that were ranked number seven on a list. The recommendation engine 402 may update the preferences of the consumer to reflect that the selected dress pants are preferred by the consumer over the six higher ranked types of pants.

The analytics component 408 may also be accessed and used by third parties. For example, merchants may use the analytics component 408 to request reports from the recommendation engine 402 that specify how many consumers have been recommended pants sold by that merchant. A merchant may use this information for inventory planning, sales campaigns, marketing, etc. A merchant may also use this information to determine what salable items are being purchased from a first merchant compared to salable items being purchased from a second merchant.

In an example, a merchant uses the analytics component 408 to determine what styles of dress pants are liked and recommended by cohorts. In response to this information, the merchant may design future styles of dress pants based on the styles most liked or recommended. In another example, a merchant server 308b is communicatively coupled to an inventory server, which is configured to plan demand for different salable items for a merchant. The inventory server may access the analytics component 408 to determine which styles, brands, etc. of salable items are most recommended to consumers. In respond to this information, the inventory server orders salable items that correspond to the most recommended salable items.

In some embodiments, the analytics component 408 may enable a merchant to request consumer data for individual consumers. Thus, a merchant may view which salable items are recommended for which consumers. In response, the recommendation component 312 of a merchant server 308 may provide targeted advertisements to consumers based on those consumer's own recommendations.

### Processor

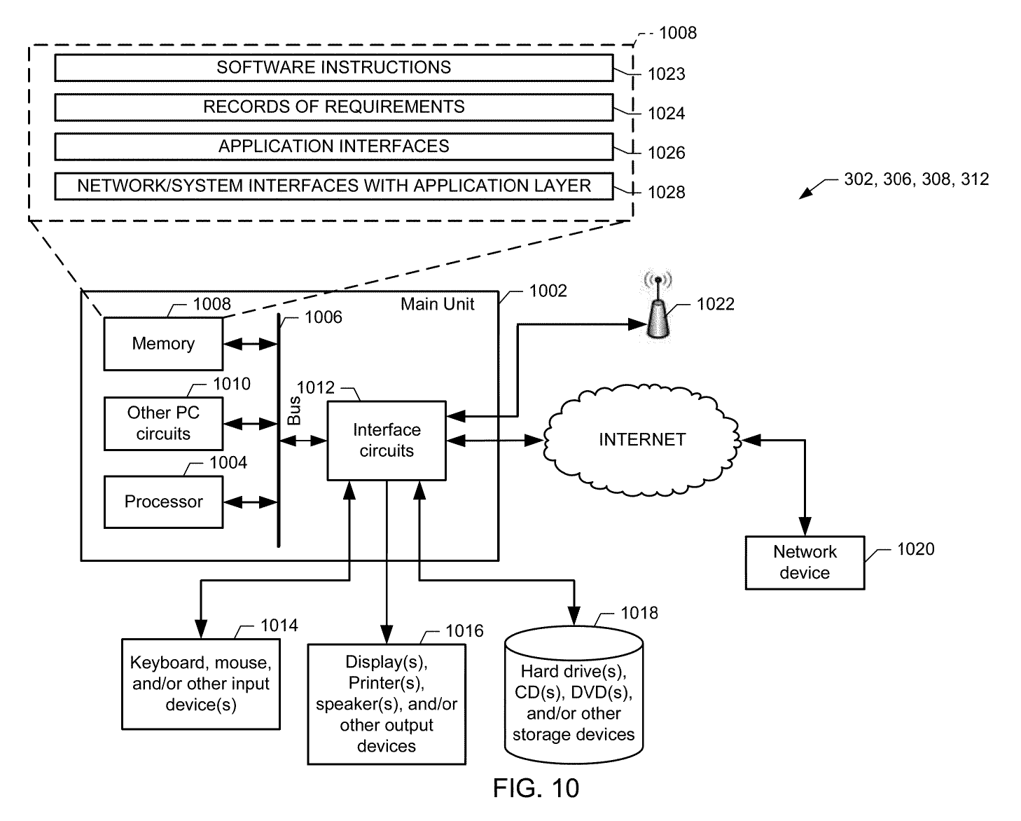

A detailed block diagram of electrical systems of an example computing device (e.g., a recommendation server 302, a consumer device 306, and/or a third-party server 308) is illustrated in FIG. 10. In this example, the recommendation server 302, the consumer device 306, and/or the third-party server 308 includes a main unit 1002 which preferably includes one or more processors 1004 communicatively coupled by an address/data bus 1006 to one or more memory devices 1008, other computer circuitry 1010, and one or more interface circuits 1012. The processor 1004 may be any suitable processor, such as a microprocessor from the INTEL PENTIUM® or CORE™ family of microprocessors. The memory 1008 preferably includes volatile memory and non-volatile memory. Preferably, the memory 1008 stores a software program that interacts with the other devices in the system 100, as described below. This program may be executed by the processor 1004 in any suitable manner. In an example embodiment, memory 1008 may be part of a “cloud” such that cloud computing may be utilized by the recommendation server 302, the consumer device 306, and/or the third-party server 308. The memory 1008 may also store digital data associated with purchase history, consumer profiles, salable items, programs, cohort information, cluster information, preferences, behaviors, meta-data, web pages, etc. retrieved from the recommendation server 302, the consumer device 306, and/or the third-party server 308 and/or loaded via an input device 1014.

The example memory devices 1008 store software instructions 1023, records of requirements 1024, consumer interface features, consumer VPN records, permissions, protocols, configurations, preference information, and/or application interface information 1026 (e.g., information for accessing and using a recommendation application). The memory devices 1008 also may store network or system interface features, permissions, protocols, configuration, and/or network interface information 1028 (e.g., information associated with the interface 404 and/or the recommendation component 312) for use by the recommendation server 302, the consumer device 306, and/or the third-party server 308. It will be appreciated that many other data structures and records may be stored in the memory device 1008 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 1012 may be implemented using any suitable interface standard, such as an Ethernet interface and/or a Universal Serial Bus (USB) interface. One or more input devices 1014 may be connected to the interface circuit 1012 for entering data and commands into the main unit 1002. For example, the input device 1014 may be a keyboard, mouse, touch screen, track pad, track ball, isopoint, image sensor, character recognition, barcode scanner, microphone, and/or a speech or voice recognition system.

One or more displays, printers, speakers, and/or other output devices 1016 may also be connected to the main unit 1002 via the interface circuit 1012. The display may be a cathode ray tube (CRTs), a liquid crystal display (LCD), or any other type of display. The display generates visual displays generated during operation of the recommendation server 302, the consumer device 306, and/or the third-party server 308. For example, the display may provide a user interface and may display salable item recommendations provided by the recommendation server 302. A user interface may include prompts for human input from a user of the consumer device 306 including links, buttons, tabs, checkboxes, thumbnails, text fields, drop down boxes, etc., and may provide various outputs in response to the user inputs, such as text, still images, videos, audio, and animations.

One or more storage devices 1018 may also be connected to the main unit 1002 via the interface circuit 1012. For example, a hard drive, CD drive, DVD drive, and/or other storage devices may be connected to the main unit 1002. The storage devices 1018 may store any type of data, such as purchase history, records, requirements, transaction data, operations data, salable item information, statistical data, security data, etc., which may be used by the recommendation server 302, the consumer device 306, and/or the third-party server 308.

The recommendation server 302, the consumer device 306, and/or the third-party server 308 may also exchange data with other network devices 1020 via a connection to the Internet or a wireless transceiver 1022 connected to the Internet. Network devices 1020 may include one or more servers, which may be used to store certain types of data, and particularly large volumes of data which may be stored in one or more data repository. A server may include any kind of data including databases, programs, files, libraries, records, images, documents, requirements, transaction data, operations data, configuration data, index or tagging data, purchase information, salable item information, statistical data, security data, etc. A server may store and operate various applications relating to receiving, transmitting, processing, and storing the large volumes of data. It should be appreciated that various configurations of one or more servers may be used to support and maintain the system 300. For example, servers may be operated by various different entities. Also, certain data may be stored in the recommendation server 302, the consumer device 306, and/or the third-party server 308 which is also stored on a server, either temporarily or permanently, for example in memory 1008 or storage device 1018. The network connection may be any type of network connection, such as an Ethernet connection, digital subscriber line (DSL), telephone line, coaxial cable, wireless connection, etc.

Access to the recommendation server 302, the consumer device 306, and/or the third-party server 308 can be controlled by appropriate security software or security measures. An individual users' access can be defined by the recommendation server 302, the consumer device 306, and/or the third-party server 308 and limited to certain data and/or actions. Accordingly, users or consumers of the system 300 may be required to register with one or more of the recommendation server 302, the consumer device 306, and/or the third-party server 308.

### Flowchart of Example Consumer Registration

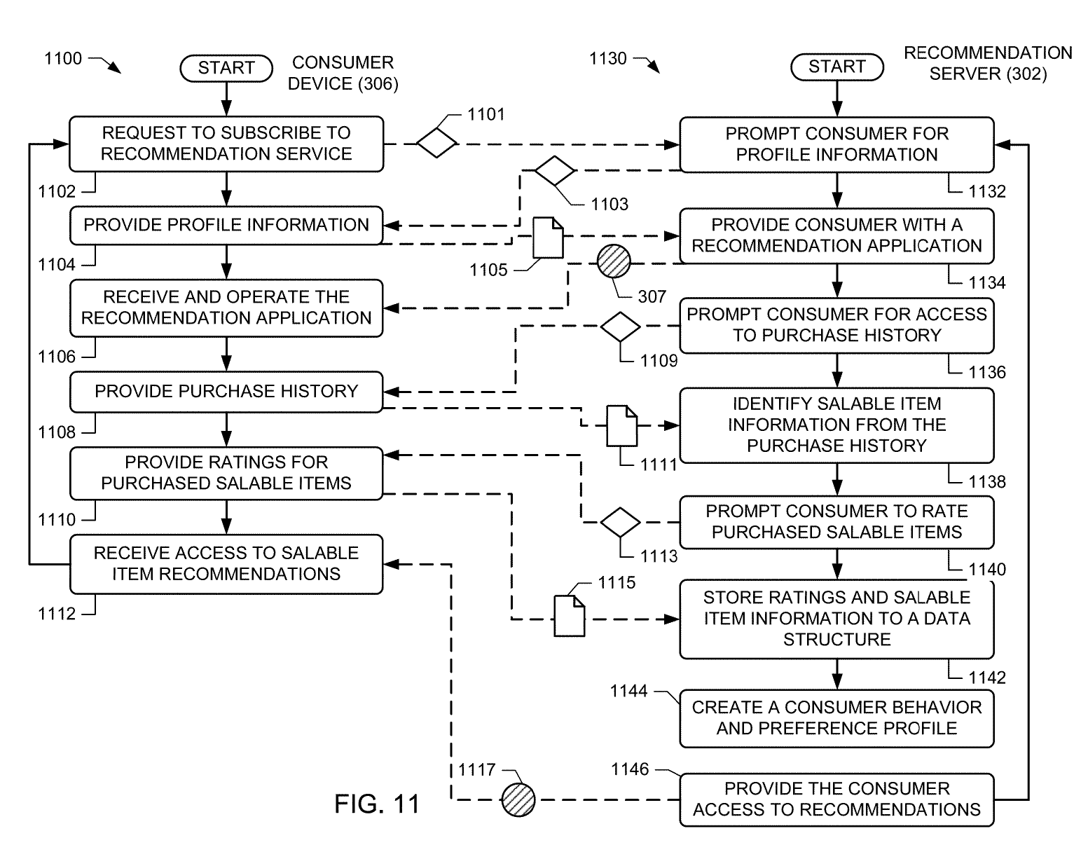

FIG. 11 is a flow diagram illustrating example procedures 1100 and 1130 to register a consumer for a recommendation service hosted by the recommendation server 302, according to an example embodiment of the present invention. The example procedures 1100 and 1130 may be carried out by, for example, the recommendation server 302 and the consumer devices 306 described in conjunction with FIGS. 2, 3, 4, and 10. Although the procedures 1100 and 1130 are described with reference to the flow diagram illustrated in FIG. 11, it will be appreciated that many other methods of performing the functions associated with the procedures 1100 and 1130 may be used. For example, the order of many of the blocks may be changed, certain blocks may be combined with other blocks, and many of the blocks described are optional.

The procedure 1100 begins when a consumer device 306 transmits a request 1101 (e.g., a message) to subscribe to a recommendation service hosted by the recommendation server 302 (block 1102). The request 1101 can include accessing a website operated by the recommendation server 302 or, alternatively, can include downloading an application (e.g., App) associated with the recommendation server 302. After transmitting the request 1101, the consumer device 306 receives a prompt 1103 (e.g., a message) to provide profile information. In response to the prompt 1103, the consumer device (via a consumer) provides profile information 1105 (block 1104). The profile information can include, for example age, height, weight, location, credit card information, body type (e.g., biographical data associated with the consumer).

The consumer device 306 next receives a recommendation application 307. The recommendation application 307 provides an interface that enables a consumer to provide purchase history (block 1106). The recommendation application 307 also provides an interface that enables the recommendation server 302 to display salable item recommendations at the consumer device 306. The recommendation application 307 organizes the recommendations such that a consumer may search for a specific salable item category and/or a specific salable item.

After installing the recommendation application 307 on the consumer device 306, the recommendation application 307 (via the recommendation server 302) prompts 1109 the consumer for purchase history. The prompt 1109 includes, for example, a request for a consumer to provide access to one or more e-mail addresses, credit card accounts, and/or merchant accounts. In response to this prompt 1109, the consumer device 306 transmits information indicative of a purchase history 1111 including, for example, account names, passwords, etc. (block 1108).

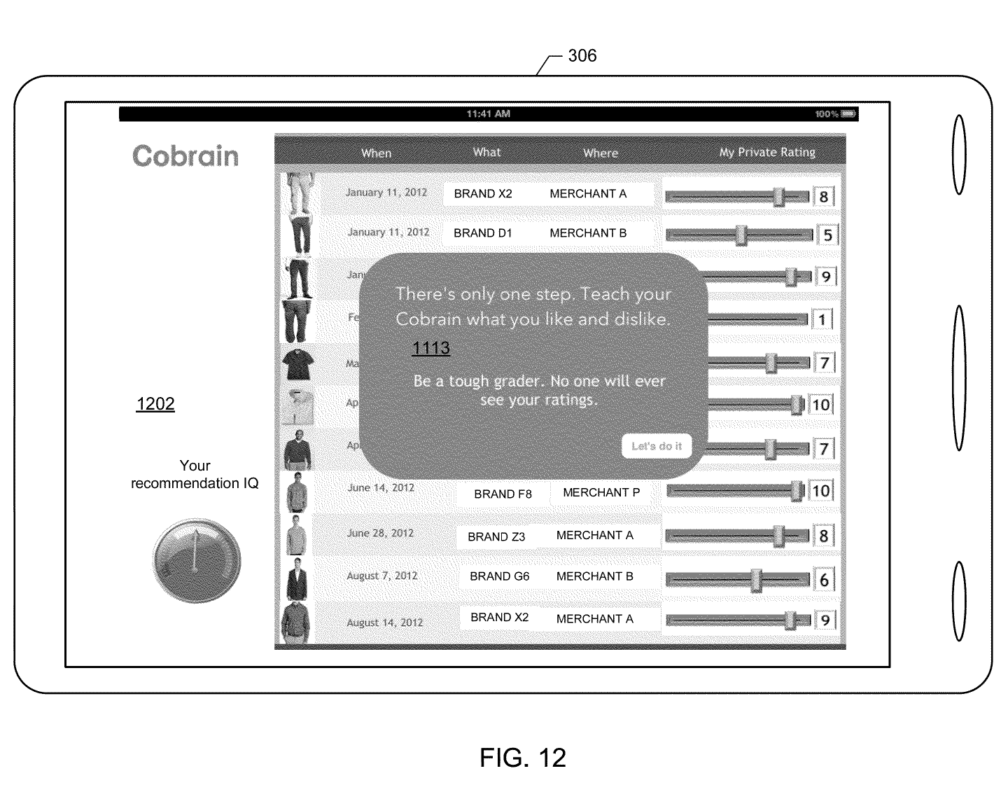

The consumer device 306 then receives a prompt 1113 from the recommendation server 302 to provide a rating for each of the salable items identified within the accounts provided by the consumer. FIG. 12 shows a diagram of the prompt 1113 displayed by the consumer device 306 within a user interface 1202. The prompt 1113 requests for a consumer to use the consumer device 306 to provide a rating for the salable items shown within the interface 1202. To help the consumer recall the purchases, the recommendation server 302 provides a date of the purchase, a brand associated with the salable item, a graphical representation of the salable item, and a merchant that sold the salable item. It should be appreciated that in other embodiments the recommendation server 302 can also provide a size, color, a description, etc.

The consumer uses the scroll function of the consumer device 306 to view and rate each of the salable items. The recommendation application 307 manages the collection of ratings provided by the consumer. After rating the salable items, the consumer device 306 transmits a message 1115 including the ratings to the recommendation server 302 (block 1110). After providing the ratings, the consumer device 306 receives access 1117 to the recommendation service (block 1112). The access 1117 may include a message that enables the recommendation application 307 to access the recommendation service. The access 1117 may also include a username, password, and/or link to the recommendation service. The access 1117 may further include a confirmation that the recommendation service has been made available to the consumer device 306 at the recommendation server 302. After receiving access, the example procedure 1100 returns to block 1102 to register another consumer device 306. Alternatively, the example procedure 1100 ends.

The example procedure 1130 of FIG. 11 begins when the recommendation server 302 receives a request 1101 from a consumer device 306 and provides a prompt 1103 to the consumer device 306 (block 1132). The prompt 1103 includes a request for profile information. Later, the recommendation server 302 receives the requested profile information 1105. The recommendation server 302 then transmits a recommendation application 307 to the consumer device 306 (block 1134). In other embodiments, the consumer device 306 may receive the recommendation application 307 from an app store. In these embodiments, the app store may relay the profile information 1105 to the recommendation server 302.

After providing the consumer device 306 with the application 307, the recommendation server 302 transmits a prompt 1109 causing the application 307 to prompt a consumer for access to purchase history (block 1136). In response to receiving the purchase history 1111 (e.g., access to an account associated with the consumer), the recommendation server 302 accesses the account(s) and identifies salable item information (block 1138). The recommendation server 302 identifies salable item information by searching an e-mail account for e-mails that include purchase receipts and reading the information in the purchase receipts. The recommendation server 302 may also identify salable item information by searching credit card statements for purchases that are associated with salable items. The recommendation server 302 may further identify salable items by accessing one or more merchant servers 308 and requesting purchase history for the associated consumer. In some embodiments, the recommendation server 302 may only identify purchases made within a predetermined time period (e.g., the last 90 days).

The example recommendation server 302 next transmits a prompt 1113 to the consumer device 306 asking the consumer to provide a rating for each identified purchased salable item (block 1140). The prompt 1113 can include information identifying the previously purchased salable items. Some time later the recommendation server 302 receives the ratings 1115 from the consumer device 306 and accordingly stores the ratings in conjunction with information associated with the purchased salable items to the database 310 (block 1142).

The example recommendation server 302 also creates consumer behavior and preference profiles based on the stored information (block 1144). The recommendation server 302 analyzes the purchase history and ratings to determine correlations between salable item categories, purchasing behaviors associated with the consumer, and/or purchasing preferences. The recommendation server 302 uses meta-data and any other information included within the purchase history (or cross-referenced to saleable item information provided by merchants) to help provide salable item recommendations. As discussed above in conjunction with FIG. 4, the behaviors may include any inferences that describes when and how a consumer purchases a salable item and the preferences may include consumer trends for purchasing a typical size, color, brand, type, etc.

The recommendation server 302 further provides the consumer device 306 access 1117 to the recommendation server 302 (block 1146). As discussed above, the access 1117 may include a confirmation of permission to use the recommendation service. Alternatively, the access 1117 can include a key to enable the recommendation application 307 to access the recommendation service. The example procedure 1130 then returns to block 1132 to register the next consumer. Alternatively, the example procedure 1130 ends.

### Flowchart of Receiving and Using Salable Item Recommendations

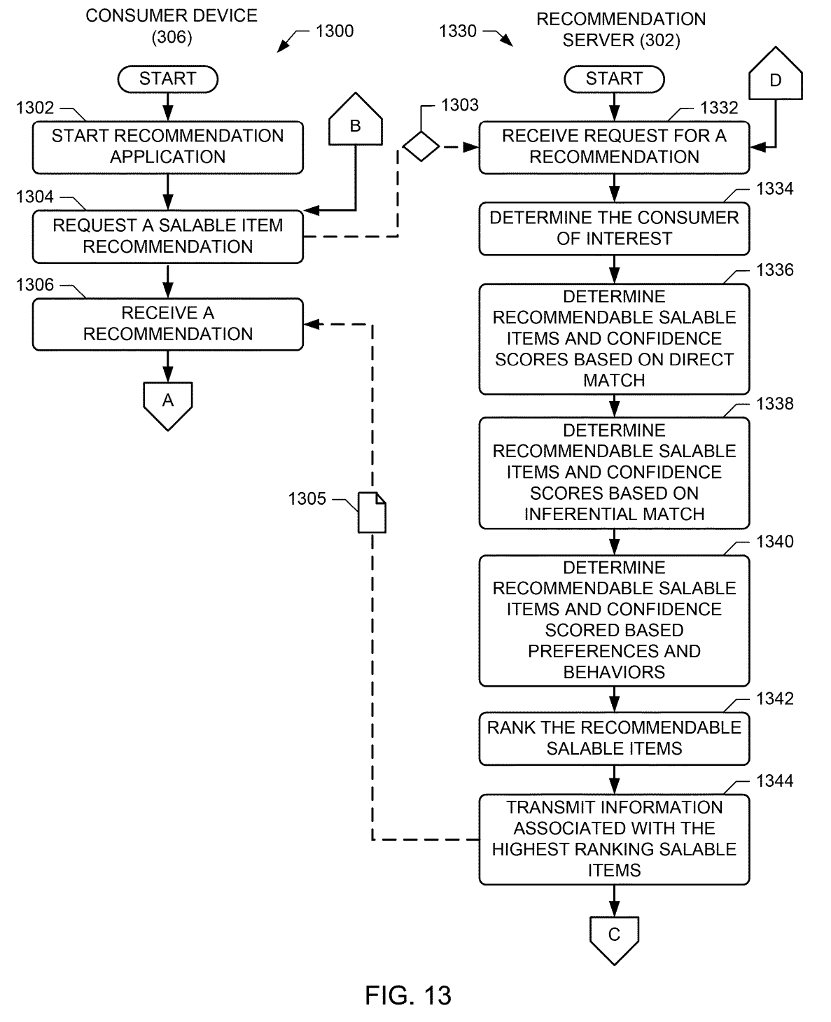

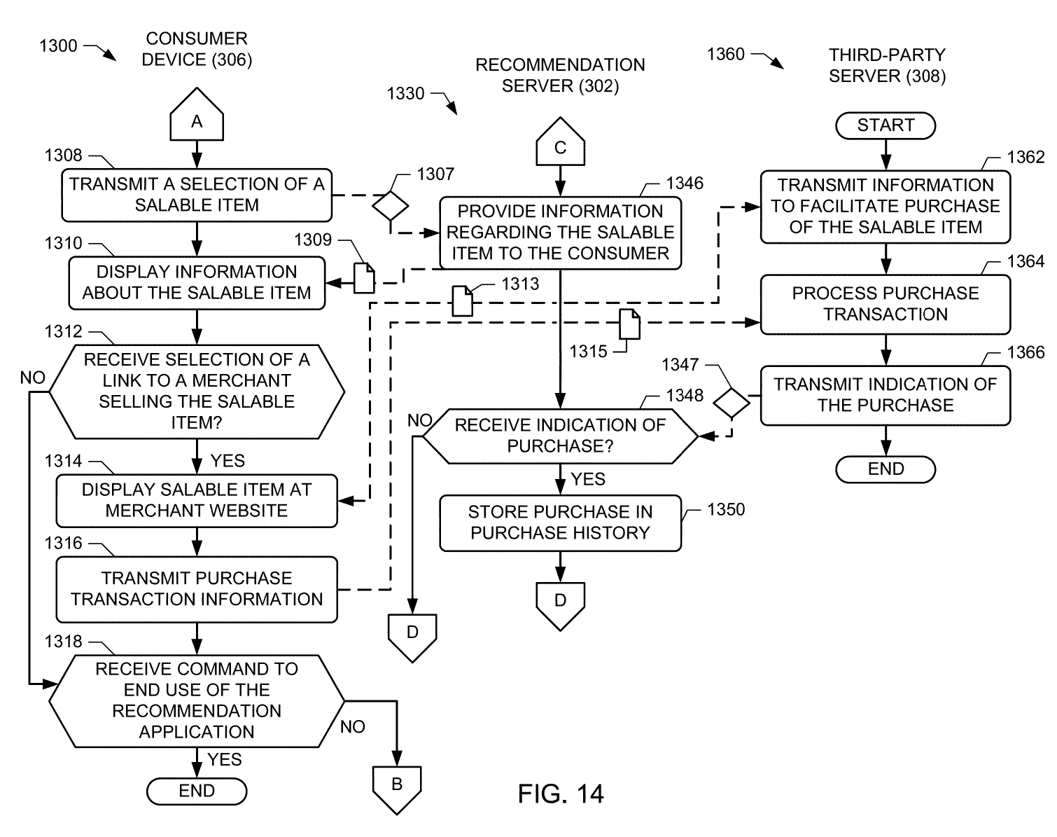

FIGS. 13 and 14 show a flow diagram illustrating example procedures 1300, 1330, and 1360 to provide salable item recommendations for a consumer, according to an example embodiment of the present invention. The example procedures 1300, 1330, and 1360 may be carried out by, for example, the consumer devices 306, the third-party servers 308, and/or the recommendation server 302 described in conjunction with FIGS. 2, 3, 4, and 10. Although the procedures 1300, 1330, and 1360 are described with reference to the flow diagram illustrated in FIGS. 13 and 14, it will be appreciated that many other methods of performing the acts associated with the procedures 1300, 1330, and 1360 may be used. For example, the order of many of the blocks may be changed, certain blocks may be combined with other blocks, and many of the blocks described may be optional.

The procedures 1300, 1330, and 1360 of FIGS. 13 and 14 describe an embodiment as to how consumers receive and use salable item recommendations provided by the recommendation server 302. In other embodiments, consumers may receive recommendations through a third-party server 308. However, in these other embodiments the recommendation server 302 provides salable item recommendations to the third-party servers 308.

The example procedure 1300 begins when the consumer device 306 starts a recommendation application 307 (block 1302). In some embodiments the consumer device 306 operates the recommendation application 307 in response to an input from a consumer (e.g., a request to start the application). In other embodiments, the consumer device 306 may operate the recommendation application 307 after detecting that a consumer is searching for one or more salable items via a search engine, a map program, etc. In yet other embodiments, the consumer device 306 accesses a recommendation website hosted by the recommendation server 302.

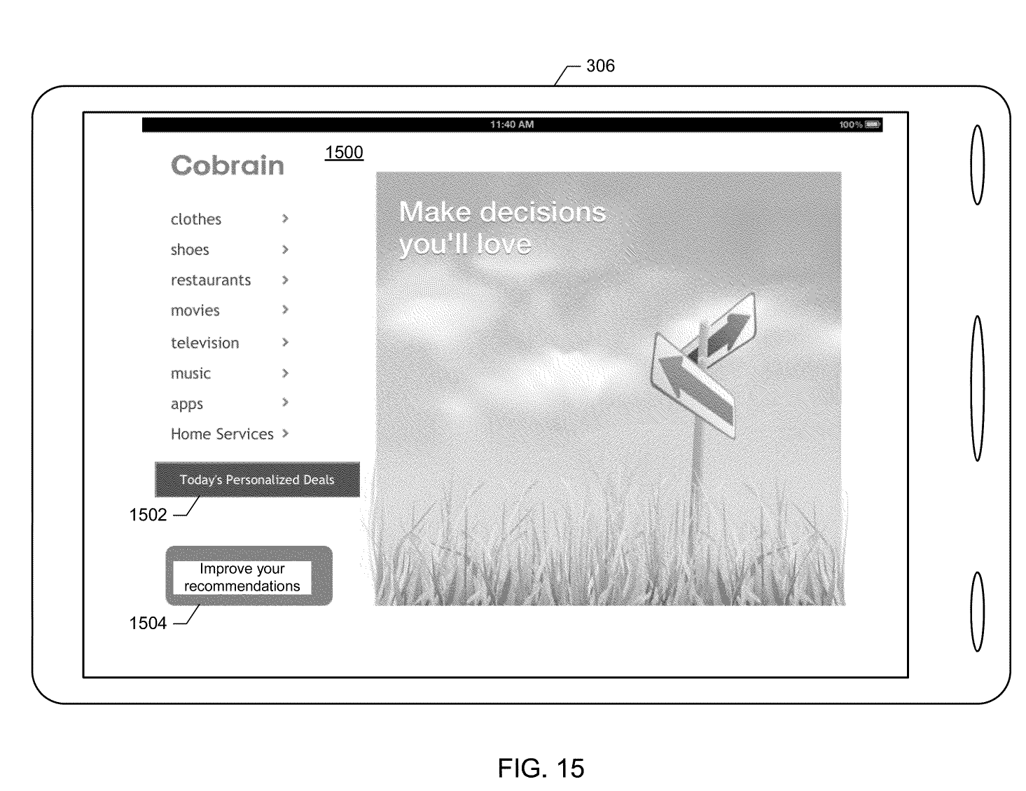

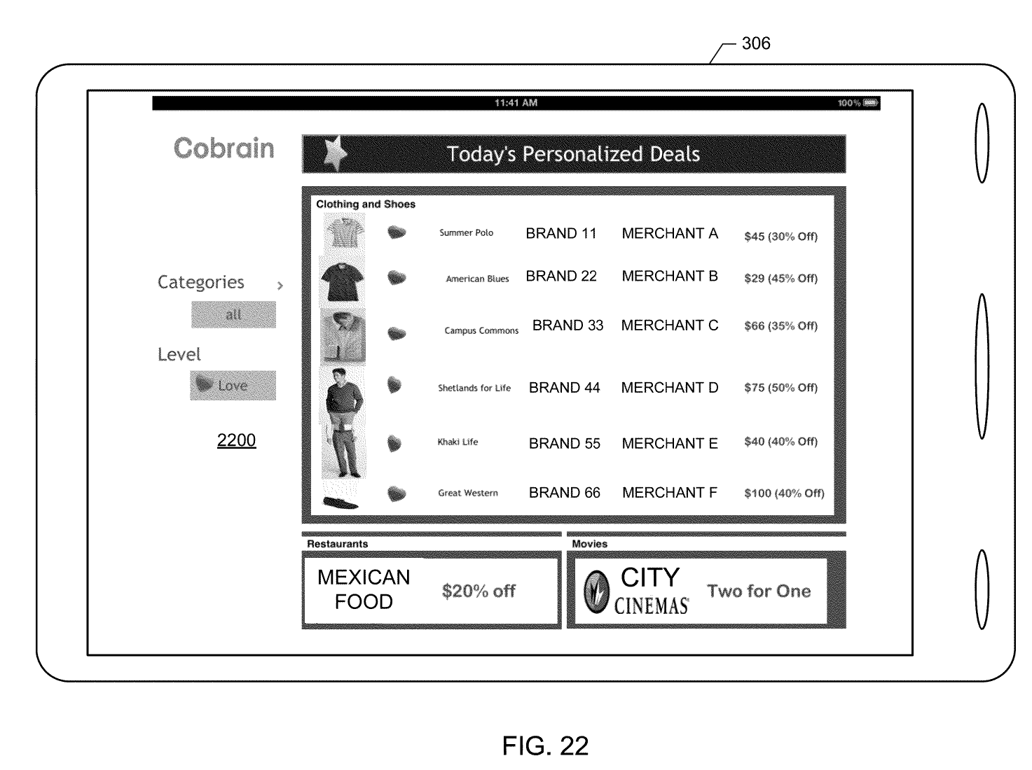

For example, FIG. 15 shows a diagram of a homepage 1500 displayed by the recommendation application 307 on consumer device 306. The homepage 1500 includes salable item categories (e.g., Clothes, Shoes, Restaurants, Movies, etc.) from which a recommendation is available. Each of the categories may include one or more sub-categories, and those sub-categories may include further lower level categories based on an amount of hierarchy used to organize salable items into distinct categories. The homepage 1500 also includes a personalized deals icon 1502, which is described further in conjunction with FIG. 22. The homepage 1500 also includes a purchase history icon 1504 that enables a consumer to disclose purchases, as described in conjunction with FIGS. 12 and 13.

The consumer device 302 transmits a request message 1303 that includes a request for a salable item recommendation (block 1304). The salable item recommendation can include, for example, a recommendation for salable items associated with a salable item category. The request message 1303 can also include a request for salable items within a certain physical distance from the consumer device 306. The request message 1303 can further include a request for one or more specific salable items. Additionally or alternatively, the request message 1303 can also include a request from the consumer to modify a parameter being used to determine a cohort group and/or confidence scores. For instance, a consumer may request to view a cohort group and recommended salable items for consumers who are younger, shop at different stores, have preferences for different colors, spend more on salable items, etc.

In the illustrated example, a consumer selects one of the salable item categories (and/or sub-categories) shown on the homepage 1500 of FIG. 15. The selection causes the recommendation application 307 to transmit via the consumer device 306 the request 1303, which includes an identity of the consumer and an identifier of the selected category. In other embodiments, the recommendation application 307 accesses a memory on the consumer device 306 to retrieve previously stored recommendations.

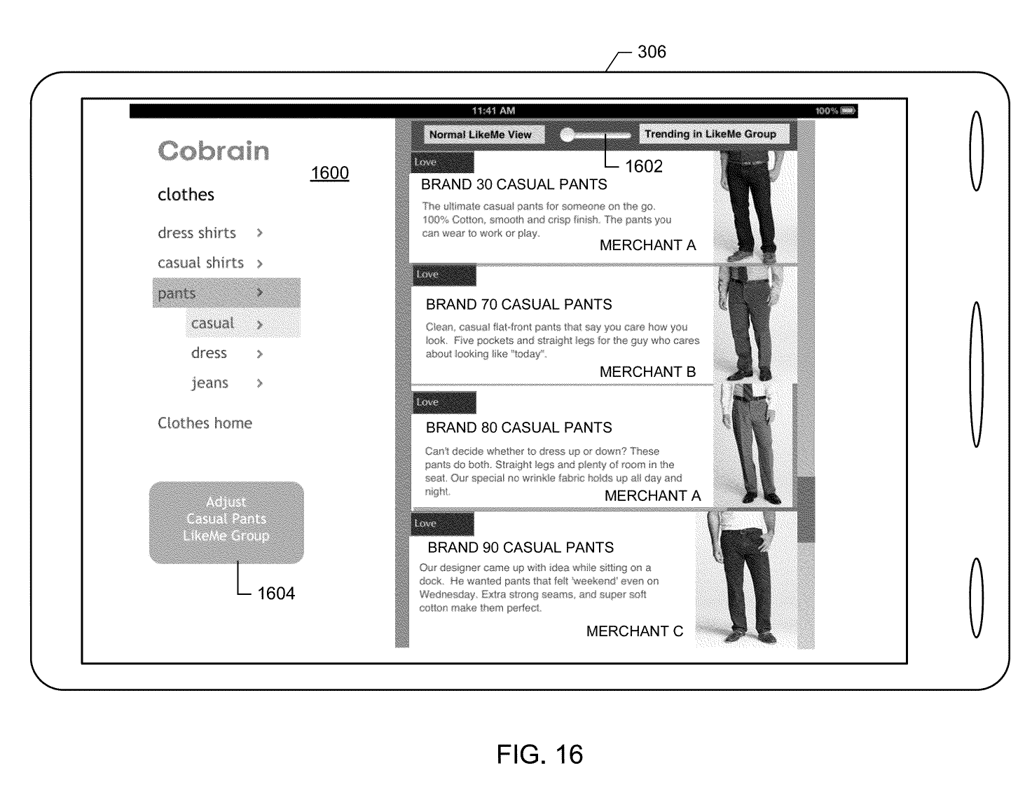

In response to the request 1303, the consumer device 306 receives a data structure 1305 that includes salable item recommendations (block 1306). FIG. 16 shows a diagram of a recommendation page 1600 displayed by the recommendation application 307 on consumer device 306. In this embodiment, a consumer requests recommendations for casual pants. In response, the recommendation server 302 transmits the data structure 1305 that includes information describing types of casual pants most likely to be enjoyed by the consumer based on calculated confidence scores. The data structure 1305 includes, for example, the top seven types of casual pants having the highest confidence scores. The recommendation application 307 displays the information regarding the casual pants including, for example, a name of the pants, a description, a merchant that sells the pants, and a graphical representation of the pants. The recommendation application 307 orders the pants such that the pants with the highest confidence score is displayed first and/or at the top of the list. The recommendation application 307 enables a consumer to use a touchscreen of the consumer device 306 to view additional recommended pants.

It should be noted that the recommendation server 302 may cause the salable items to be displayed in colors, sizes, etc. based on preferences and behaviors of the consumer. In FIG. 16, the recommendation server 302 may select the color for each type of casual pants based on which colors the consumer has previously purchased. Alternatively, the colors may be selected based on which colors were most purchased by cohorts. Similar to color, the recommendation server 302 may select which merchant is displayed in instances where more than one merchant sells the same salable item. Again, the recommendation server 302 selects the merchant based on preferences/behaviors of the consumer and/or previous purchases of cohorts.

FIG. 16 also includes a trending bar 1602, that enables a consumer to modify which salable items (e.g., casual pants) are recommended based on which cohorts have purchased casual pants more recently. For instance, a consumer may change a location of the button on the trending bar 1602, causing the recommendation application 307 to transmit a message to the recommendation server 302 including an indication of the location of the movement of the button within the trending bar 1602. This message causes the recommendation server 302 to recalculate confidence scores for the casual pants by applying more scoring weight to relatively recent purchases and/or casual pants that have sold relatively quickly within a short time period. The recommendation server 302 then transmits a data structure 1305 including the information associated with the newly recommended casual pants. In this manner, the trending bar 1602 in conjunction with the recommendation server 302 enables a consumer to view recommended salable items that have been recently purchased by cohorts.

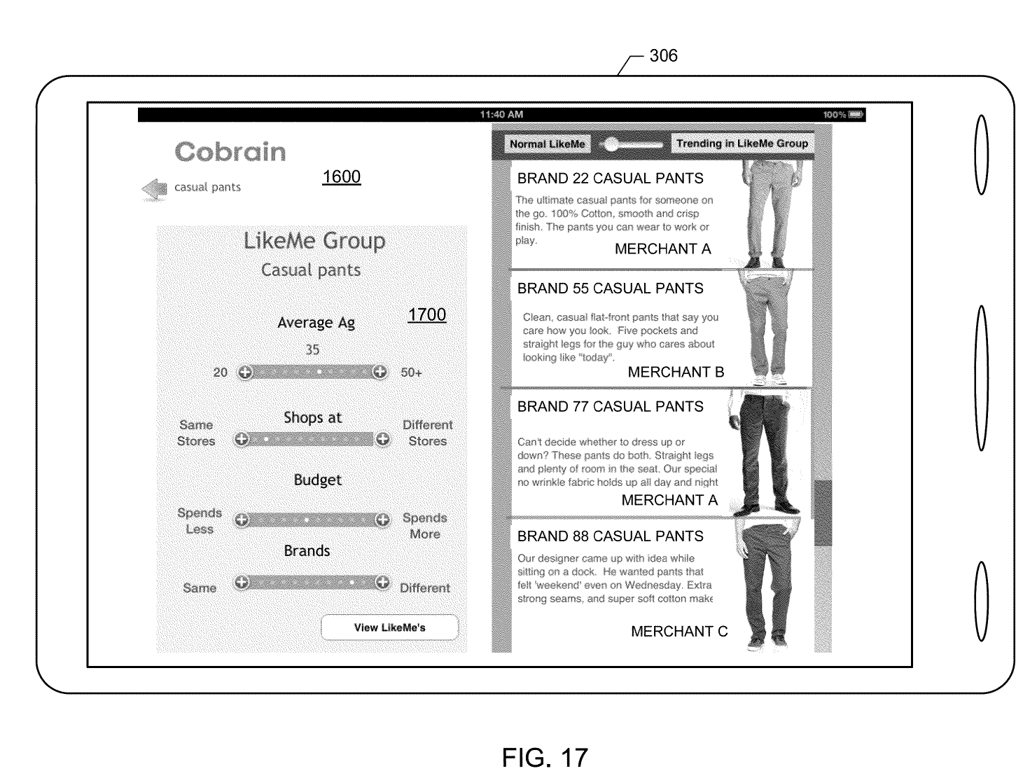

The recommendation page 1600 of FIG. 16 also includes a cohort adjustment icon 1604. A consumer may select this icon 1604 causing the recommendation application 307 to display an adjustment window 1700. FIG. 17 shows a diagram of the recommendation page 1600 including the adjustment window 1700 after a consumer selected the adjustment icon 1604. The adjustment window 1700 enables a consumer to change preferences or behaviors used by the recommendation server 302 to formulate recommendations.

As described above in conjunction with FIG. 4, the recommendation engine 402 determines consumer preferences and behaviors based on previous purchases. The adjustment window 1700 shows some of these behaviors and preferences, including an average shopping age of the consumer indicator, a preference for the same stores indicator, a budget indicator, and a brands indicator. A consumer may modify the preferences or behaviors on one or more of the indicators causing the recommendation engine 402 to recalculate confidence scores. This enables a consumer to view salable item recommendations based on someone with different preferences and behaviors. For instance, a consumer modifies the budget indicator to view which casual pants would be recommended if the consumer spent more on casual pants. In another instance, the consumer modifies the average age indicator to view which casual pants would be recommended if the consumer is associated with younger or older cohorts. In each of these instances, the recommendation engine 402 recalculates confidence scores based on the amended preferences and behaviors and returns a data structure 1305 to the consumer device with the new salable item recommendations. In this manner, the recommendation engine 402 uses the information associated with a plurality of cohorts to replicate or simulate a purchasing behavior for a particular consumer.

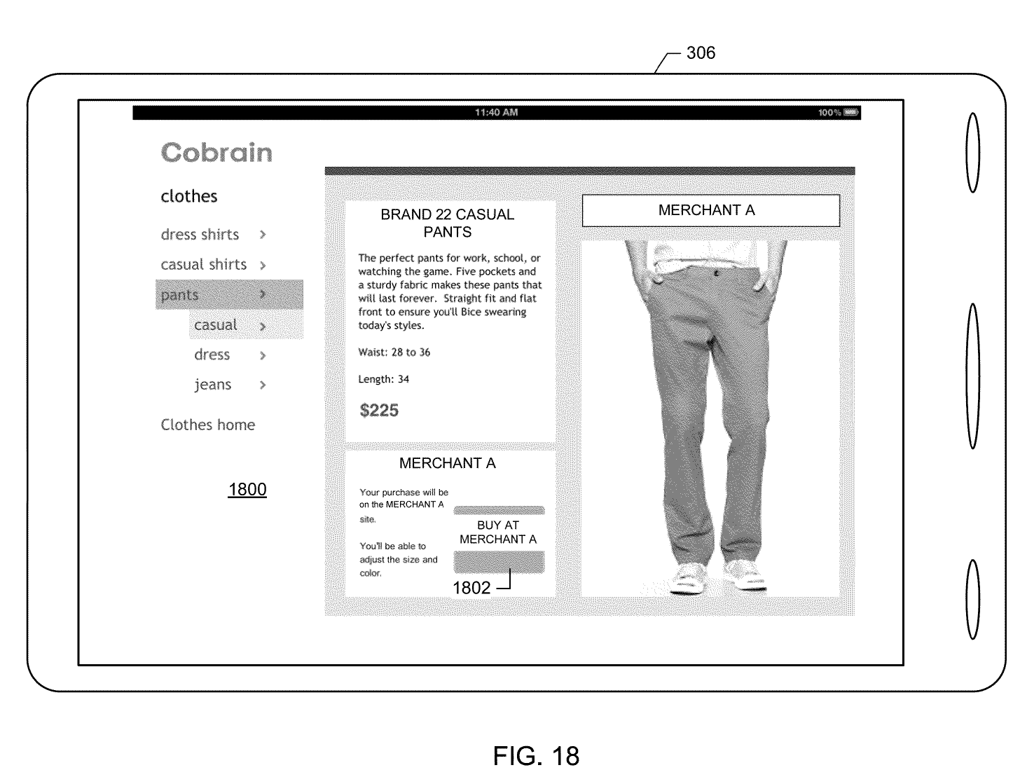

Returning to FIGS. 13 and 14, after viewing recommended salable items, the consumer device 306 transmits a message 1307 that identifies a selection of a salable item (block 1308). In response, the consumer device 306 receives a data structure 1309 that includes additional information associated with the selected salable item (block 1310). For example, FIG. 18 shows a diagram of a product page 1800 displayed by the recommendation application 307 on the consumer device 306. In this example, a consumer selects to view the “Brand 22 Casual Pants.” In response to the selection, the recommendation server 302 transmits additional information associated with the casual pants. The information includes, for example, a link to a merchant selling the pants, a description, available sizes, available colors, price, etc. In other embodiments, the recommendation application 307 may have already received the salable item information within the data structure 1305. In these other embodiments, the recommendation application 307 displays the product page 1800 without additionally accessing the recommendation server 302.

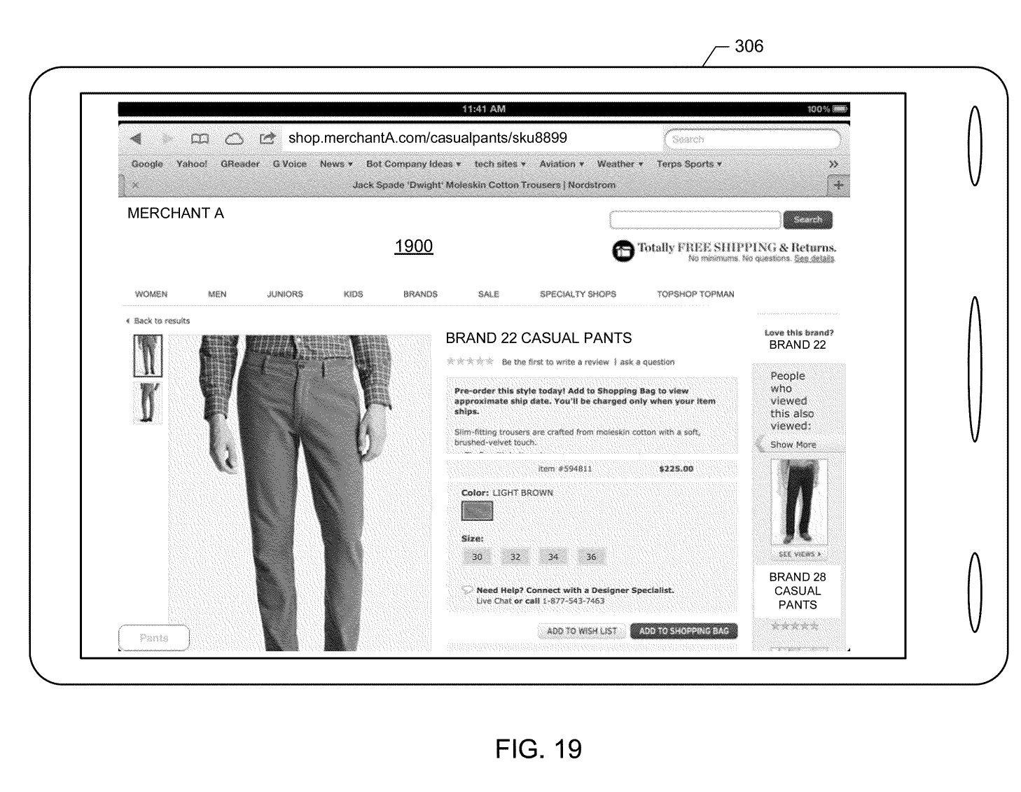

The consumer device 306 next determines if a consumer has selected a link (e.g., a link embedded within icon 1802) to a merchant (e.g., a third-party server 308) selling the salable item (block 1312). If the icon 1802 is selected, the consumer device 306 exchanges website information 1313 with a merchant associated with a web address specified in the link embedded within the icon 1802. The information 1313 enables the recommendation application 307 (or a web browser) on the consumer device 306 to display, for example, a webpage 1900 offering for sale the casual pants, as shown in FIG. 19 (block 1314). FIG. 19 shows only one example of a merchant webpage from which a consumer can purchase a recommended salable item. It should be appreciated that different merchants have different webpages for selling their salable items.

In the embodiment of FIG. 14, the consumer device 306 transmits purchase information 1315 (e.g., credit card information, address, etc.) to the third-party server 308 to complete the purchase of the salable item (block 1316). At this point, the consumer has purchased a recommended salable item. Sometime in the future (e.g., within a few days or weeks), the recommendation server 302 may prompt the consumer via the consumer device 306 to rate the purchased salable item.

In other alternative embodiments, the recommendation server 302 is configured to process the transaction. For example, upon receiving a request to purchase a salable item shown via the recommendation application 307, the recommendation server 302 provides the consumer device 306 a link to a purchase website. The recommendation server 302 hosts the website, which includes prompts for address, payment, and salable item information. After processing the transaction, the recommendation server 302 transmits a message including the transaction to the merchant associated with the purchased salable item.

In these alternative embodiments, the recommendation server 302 enables consumers to purchase salable items across different salable item categories sold by different merchants in one transaction (e.g., one-stop shopping). In instances where salable items are purchased from different merchants, the recommendation server 302 transmits only the relevant portion of the transaction to the corresponding merchant.

Returning to the example procedure 1300, the consumer device 306 determines if the consumer has requested to end the use of the recommendation application 307 (block 1318). The consumer device 306 also performs the action in block 1318 when a consumer does not select a link to view a salable item on a third-party server, as described in conjunction with block 1312. If the consumer provides a command to end use of the recommendation application 307, the example procedure 1300 ends. However, if the consumer has not provided a command to end use of the recommendation application 307, the example procedure 1300 returns to block 1304 where the consumer device 306 requests a recommendation for a salable item. In other embodiments, the procedure 1300 returns to block 1306 and displays other recommended salable items.

Procedure 1330 of FIGS. 13 and 14 begins when the recommendation server 302 receives a request message 1303 for a recommendation (block 1332). In this embodiment, the request message 1303 is received from a consumer device 306. The request message 1303 includes, for example, an identity of the consumer and a location and/or category of salable items. In other embodiments, the request message 1303 may be received from a third-party server 308. For instance, a merchant may request to receive recommendations for specific consumers (e.g., consumers subscribed to the merchant) and/or a plurality of consumers. The merchant uses the recommendation data to merchandize certain salable items to specific consumers through a website or application operated by the merchant. The merchant may also use the recommendations for in-store displays or enable sales clerks to use the recommendations when assisting a consumer select salable items to purchase. The merchant can also use the recommendations to display consumer-specific advertisements to consumers who access a website operated by the merchant.

The example recommendation server 302 identifies a consumer of interest (or consumers of interest) associated with the request (block 1334). The recommendation server 302, via the recommendation engine 402, determines recommendable salable items based on direct matching, inferential matching, preferences/behaviors and/or meta-data associated with the consumer of interest (blocks 1336, 1338, and 1340). As discussed above in conjunction with FIG. 4, the recommendation engine 402 determines confidence scores for salable item for each category requested by the consumer. The recommendation engine 402 determines the confidence scores based on previous purchases of cohorts of the consumer of interest, correlations between previous purchases, click, purchase, and rating cohort actions associated with recommended salable items, and/or preferences/behaviors associated with the consumer of interest. The action performed in block 1340 also includes determining which colors, sizes, merchant, price, etc. are to be included within the information for the corresponding recommendable salable items.

In some embodiments, the example recommendation server 302 pre-computes confidence scores for each consumer for each salable item category. This pre-computation conserves resources because the computation is conducted during off-peak usage hours (e.g., from 1 A.M. until 4 A.M.). The pre-computation may be necessary to process the hundreds of thousands to millions of cohort purchases into recommendable salable items with confidence scores. In these embodiments, the recommendation server 302 transmits recommended salable items without performing the actions specified by blocks 1334-1342 in response to receiving the request message 1303. In other embodiments, the recommendation server 302 may amend or modify the pre-calculated confidence scores and/or recommendable salable items after receiving the request message 1303.

The recommendation server 302 ranks the recommendable salable items for each requested salable item category (block 1342). The recommendation server 302 transmits information associated with the highest ranking salable items for each category within a data structure 1305 to the requesting consumer device 306 (or third-party server 308) (block 1344). In instances where the recommendations are transmitted to third-party servers 308, the recommendation server 302 may also filter the recommendations based on, for example, salable items associated with a merchant that is to receive the recommendations, salable item categories, specific salable items specified in search results, etc.

The recommendation server 302 next receives a message 1307 that identifies a selection of a salable item. In response to the message 1307, the recommendation server 302 transmits a data structure 1309 that includes information associated with the salable item to the consumer device (block 1346). The recommendation server 302 determines whether an indication message 1347 was received (block 1348). The message 1347 indicates that the consumer purchased a salable item associated with a recommendation. In some embodiments, the indication message 1347 is transmitted from, for example, a merchant server 308b. In other embodiments, the indication message 1347 is transmitted from the consumer device 306. In these other embodiments, the recommendation application 307 may create the indication message 1347 after detecting a purchase and/or after scanning an account associated with the consumer.

If no indication message 1347 is received, the recommendation server 302 returns to providing recommendations, as described in conjunction with blocks 1332-1344. However, responsive to receiving an indication message 1347, the recommendation server 302 stores a purchase history of the purchased salable item within database 310 (block 1350). It should be appreciated that block 1350 may be executed by the recommendation server 302 at any time when an indication message 1347 is received. After storing the purchase history, the recommendation server 302 returns to providing recommendations, as described in conjunction with blocks 1332-1344. After some time of storing information regarding the purchase (e.g., 30 days), the recommendation server 302 may prompt the consumer to rate the purchase.

The example procedure 1360 of FIG. 14 begins when a third-party server 308 exchanges website information 1313 with a consumer device 306 requesting to view a webpage for a purchase of a salable item (block 1362). The website information 1313 received from the consumer device 306 includes, for example, an identifier of a consumer and/or a web address. In other embodiments, the recommendation component 312 of the third-party server 308 scans the consumer device 306 for an identifier of the consumer (e.g., an identifier included within a data structure such as a cookie). The recommendation server 302 provides the third-party server 308 with information to identify the consumer including, for example, an account identifier, e-mail address, etc. The website information 1313 transmitted from the third-party server 308 includes text and webpage code to enable the consumer device 306 to display the requested webpage.

In this embodiment, the example third-party server 308 receives purchase information 1315 from the consumer device 306. The purchase information 1315 includes, for example, a salable item size, a salable item color, a date a service will occur, a salable item identifier, credit card information, consumer address, etc. The third-party server 308 uses the purchase information 1315 to process a purchase transaction (block 1364). The third-party server 308 may then provide the recommendation server 302 and/or the consumer device 306 with an indication message 1347 that includes information associated with the purchase (block 1366). After completing the transaction and providing the salable item to the consumer, the example procedure 1360 ends. In other embodiments, the third-party server 308 processes purchase transactions for other consumers.

### Embodiments of Recommendation Presentations

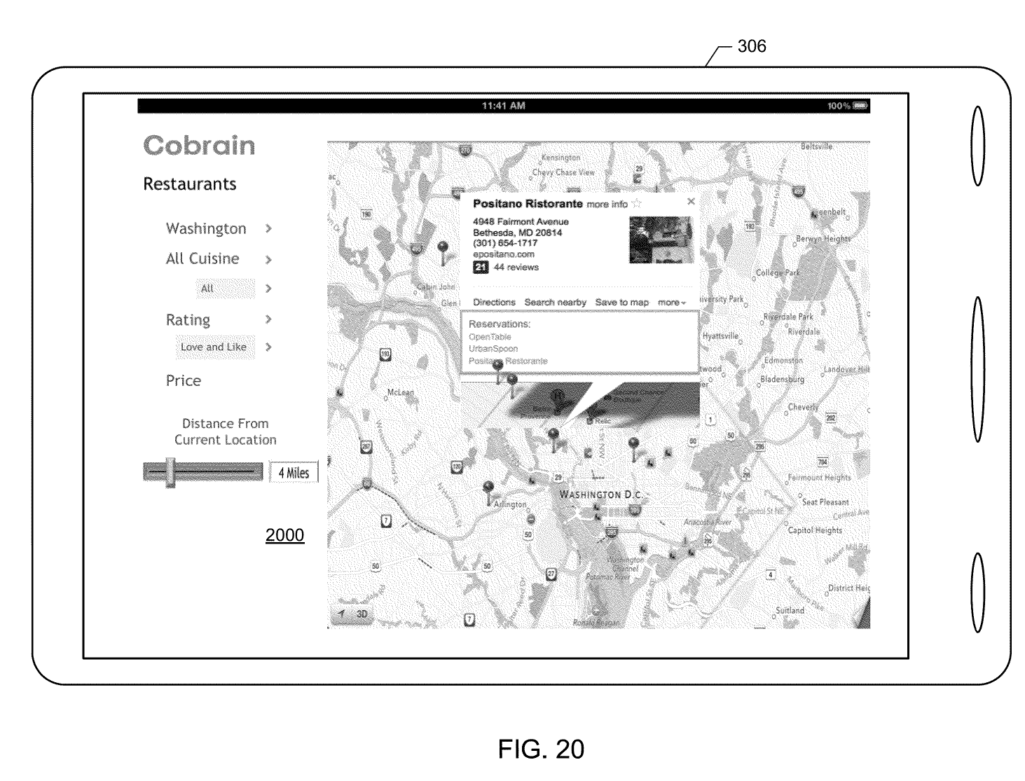

FIGS. 20 to 22 show diagrams of different embodiments of recommendations presented to a consumer via a consumer device 306. It should be appreciated that FIGS. 20 to 22 are only example embodiments and that in other embodiments recommendations can be presented to consumers in different manners. For instance, recommendations can be provided to a consumer via a pop-up window displayed by the consumer device 306, recommendations can be displayed in a list (similar to the recommendations shown in FIGS. 16 and 17), and/or the recommendations can be displayed as a rotating sequence of recommended salable items displayed within a background or wallpaper of the consumer device 306.

Further, it should be appreciated that the recommendations may be displayed differently based on the type of consumer device 306. For example, recommendations displayed on a smartphone may be relatively more compact and include fewer recommendations per screen area compared to recommendations shown on a tablet computer. Moreover, a consumer may specify how recommendations are displayed on a consumer device 306 (e.g., in a list, sequence, map, web browser, etc.).

FIG. 20 shows that recommendations can be location-based by the consumer device 306 displaying recommendations within a map interface 2000. The recommendation application 307 operates a map program in conjunction with recommendations received from the recommendation server 302. In the illustrated example, a consumer provides settings or preferences including, for example, a location (e.g., Washington), a salable item category (e.g., All Cuisine), a level of enjoyment (e.g., Love and Like), and a distance from a current location (e.g., 4 miles). The level of enjoyment is used by the recommendation server 302 to determine a threshold as to how many recommendations should be transmitted. In this embodiment, the Love and Like setting may correspond to a providing recommendations of restaurants having a confidence score of at least 70 (where the Love setting corresponds to a confidence score of at least 90).

The consumer device 306 transmits the settings to the recommendation server 302. The consumer device 306 may also use a global position system (“GPS”) to provide the recommendation server 306 a geographic location. Alternatively, the consumer can provide a zip code or an address.

Responsive to receiving setting information, the recommendation server 302 determines restaurants that match the settings and have been visited (and rated/recommended) by cohorts. In this example, the recommendation server 302 provides a data structure of restaurant recommendations within 4 miles of the consumer of interest. The recommendation application 307 displays information regarding the restaurant with the highest confidence score. In some embodiments, the recommendation application 307 may display on the map interface 2000 which restaurants the consumer will Love and which restaurants the consumer will only Like based on the confidence scores. For instance, Love restaurants may be displayed with a green icon while Like restaurants are displayed with a yellow icon. In other embodiments, the confidence score may be shown in conjunction with the location of each restaurant.

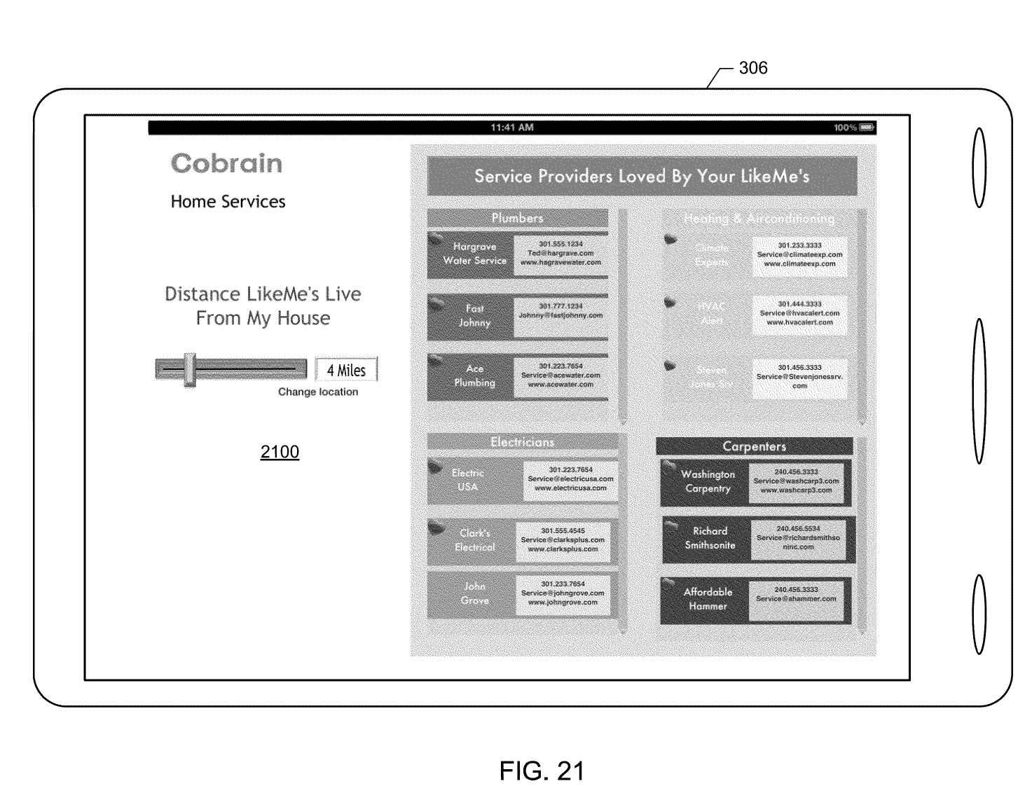

FIG. 21 shows a diagram of another location-based embodiment. In particular, FIG. 21 shows a recommendation interface 2100 displayed by the consumer device 306 via the recommendation application 307. In this embodiment, a consumer selects a salable item category (e.g., Home Services) and a distance (e.g., 4 miles). Similar to the example in FIG. 20, the recommendation server 302 of FIG. 21 uses the settings to determine salable item recommendations for different sub-categories (e.g., Plumbers, Heating and Air Conditioning, Electricians, and Carpenters) within the Home Services category. The recommendation server 302 provides one or more data structures that include information for recommended home service providers. The recommendation application 307 displays for each sub-category the information associated with the recommended service providers that are within 4 miles of the consumer.

The recommendation interface 2100 also includes heart icons next to services that have a confidence score that corresponds to a Love setting. The absence of a heart icon adjacent to a service indicates that the service has a confidence score corresponding to a Like setting. In other embodiments, the recommendation application 307 may display the confidence scores and/or different types of icons based on the confidence scores.

In addition to providing recommendations for clothing and services, the recommendation server 302 also provides recommendations for books, news items, periodicals, news web sites, blogs, short messaging accounts, etc. In these other examples, the recommendation server 302 uses the data collection component 410 to identify information accessed by a consumer. The recommendation server 302 determines cohorts who are interested in the same information and provides recommendations based on direct and inferential matching based on other information or websites accessed by the cohorts.

Moreover, in addition to providing personalized recommendation for salable items, the recommendation server 302 may also provide recommendations in conjunction with personalized deals. FIG. 22 shows a diagram of a deals interface 2200 displayed on the consumer device 306 by the recommendation application 307. Different merchants may provide indications of periodic deals to the recommendation server 302. The indications can specify, for example, specific salable items associated with the deal (e.g., SKU numbers), a price (or coupon) during the time period of the deal, and/or which consumers are authorized to receive the deal. For instance, a merchant may make a deal available only to consumers who have purchased previous salable items (or specific colors or sizes of salable items) from the merchant.

In the illustrated example, Merchant A indicates that the Summer Polo shirt manufactured by Brand 11 is 30% off of the normal price. Merchant A can also indicate that only a specific size of the shirt and/or only certain colors of the shirt are available for the deal. The merchant may also specify that the deal is available to consumers who have been recommended the Summer Polo based on a confidence score within a certain range and/or a ranking of the Summer Polo in relation to other recommended shirts.

The example recommendation server 302 updates daily the deals shown in the deals interface 2200. In other examples, the recommendation server 302 may update the deals hourly, weekly, etc. The recommendation server 302 selects the salable items to be displayed within the deals interface 2200 based on recommendable salable items with the highest confidence scores that are also associated with a personalized or daily deal. A consumer may change the salable item category to view only recommended salable items corresponding to that category that are associated with a deal. Similarly, the consumer may change the Level setting to view recommended salable items corresponding to certain ranges of confidence scores that are associated with a deal.

### Embodiments for Displaying Recommendations with Third-Party Content

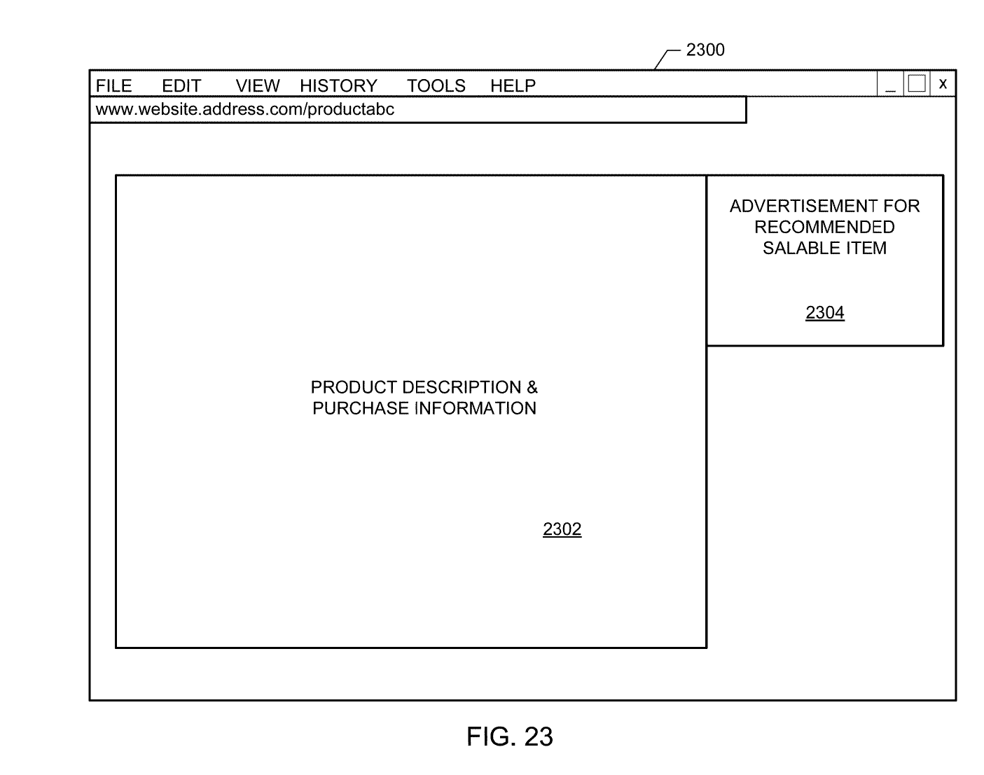

FIGS. 23 to 25 show diagrams of user interfaces 2300, 2400, and 2500 that include third-party content displayed in conjunction with recommendations provided by the recommendation server 302 of FIGS. 3, 4, 10, 11, 13, and 14. The user interfaces 2300, 2400, and 2500 may be associated with (e.g., managed/hosted) the third-party servers 308 and displayed by the consumer devices 306 The user interfaces 2300, 2400, and 2500 are only examples of how recommendations may be displayed in conjunction with third-party content. In other examples, third-party servers 308 can display salable item recommendations in any manner in relation to the content displayed on a website or an application. For instance, a merchant server 308b may display recommendations in a pop-up window or in a widget adjacent to a product page that sequences through recommendations.

FIG. 23 shows a user interface 2300 provided by a merchant. The interface 2300 is shown as a webpage displayed within a web browser. In this example, the interface 2300 includes a salable item description section 2302 that includes text, links, and/or pictures associated with one or more salable items. The interface 2300 also includes an advertisement section 2304 that displays salable item advertisements to consumers.

In an example, a consumer accesses the webpage shown within the interface 2300 by entering the webpage address of ‘www.website/address.com/productabc’ into a web browser on a consumer device 306. A merchant server 308b associated with the webpage address transmits the webpage content to the consumer device 306. A recommendation component 312b operating in conjunction with the merchant server 308b accesses the consumer device 306 to determine an identity of the consumer. In other embodiments, a recommendation application 307 provides the identity.

The recommendation component 312b then matches the identity to recommendations previously provided by the recommendation server 302. The recommendations include, for example, salable items sold by the merchant. In other embodiments, the recommendation component 307 sends a request message to the recommendation server 302 requesting recommendations associated with the consumer and/or one or more salable item categories associated with the merchant. In yet further embodiments, the recommendation application 307 provides the recommendations in conjunction with the identity of the consumer.

The merchant server 308b selects one or more of the recommended salable items for that consumer to display within section 2304. The merchant server 308b may select a recommended salable item with a highest confidence score, a recommended salable item with a highest confidence score for a particular category, a recommended salable item associated with (or related to) one or more of the salable items displayed within section 2302, a recommended salable item offered in a deal by the merchant, etc. In some embodiments, the merchant server 308b may cycle through a sequence of recommended salable items.

Further, the merchant server 308b may provide text providing why the advertised salable item is recommended. For instance, the merchant server 308b could include text that includes: “Your cohorts have enjoyed these dress pants, we think you will too!” Moreover, the merchant server 308b may display a confidence score and/or an icon indicative of a confidence score within the advertisement section 2304.

Upon a consumer selecting the salable item shown within the advertising section 2304, the third-party server 308b provides a webpage associated with the selected item. The thirty-party server 308b also provides a notification to the recommendation server 302 indicating which consumer selected which advertisement for a recommended salable item. As discussed above, the recommendation server 302 uses this information to refine preferences/behaviors of the consumer.

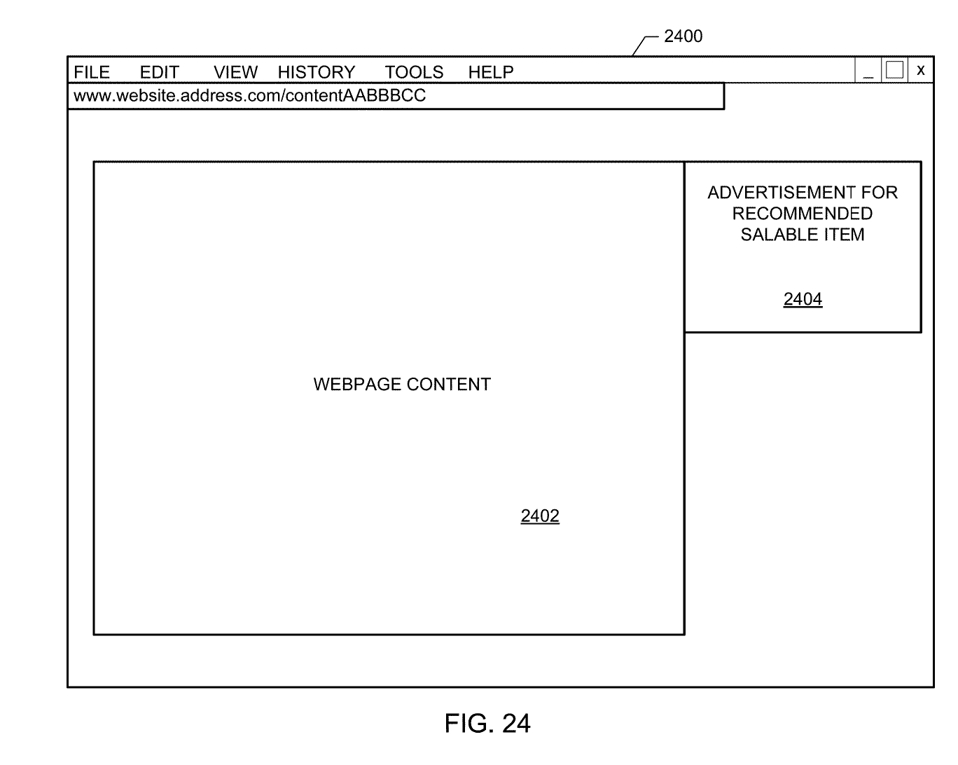

FIG. 24 shows a user interface 2400 provided by a content provider. The content provider provides any type of webpage content including for example, news, blogs, social media information, user generated content, etc. The content is displayed within a content section 2402 of the interface 2400. An advertising entity owns (or leases) space adjacent to the content section 2402 including advertisement section 2404. An advertising server 308a associated with the advertising entity selects which advertisements are displayed within the section 2404.

Similar to the recommendation component 312b described in conjunction with FIG. 23, a recommendation component 312a operating in conjunction with the advertising server 308a determines which consumer is viewing the webpage and selects one of the recommended salable items for display within section 2404. The recommendation component 312a may select a recommended salable item based on content within the section 2402, a merchant who leased advertisement time for the section 2404, a salable item category designated for the section 2404, etc. A selection of a salable item shown within the advertising section 2404 causes the advertising server 308a to redirect the consumer to a webpage associated with the item. Responsive to receiving a selection of a salable item, the advertising server 308a may provide an indication of the selection to the recommendation server 302.

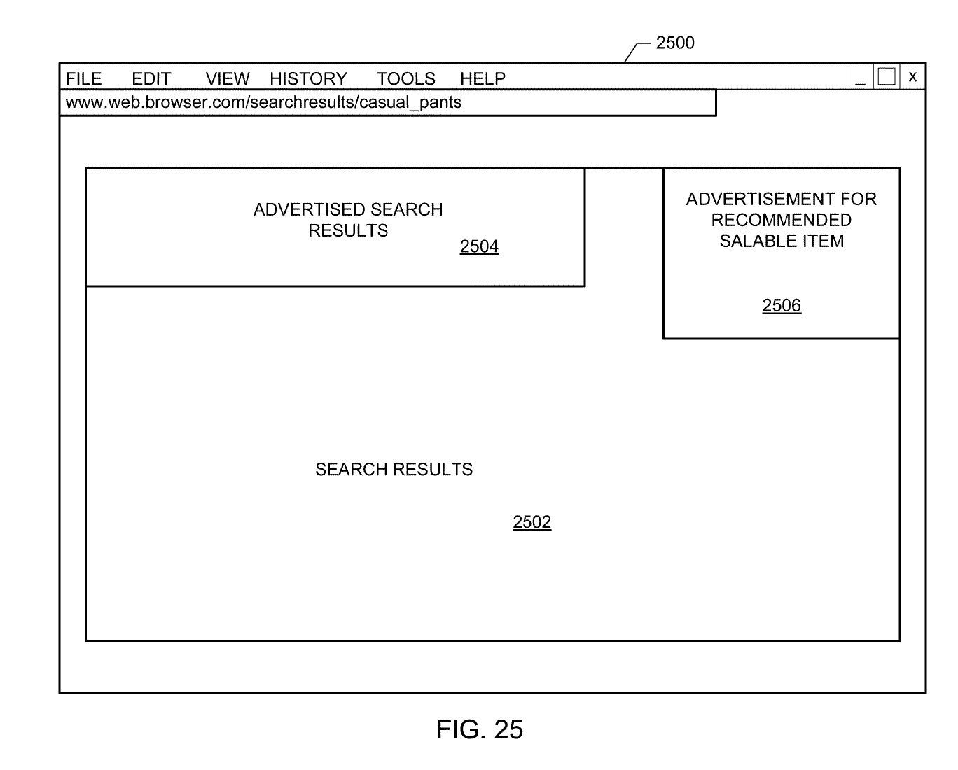

FIG. 25 shows a user interface 2500 provided by a search provider. The user interface 2500 includes a search results section 2502 configured to display search results for a consumer. The user interface 2500 also includes an advertised search results section 2504 and an advertisement section 2506. A recommendation component 312c operating in conjunction with a search server 308c transmits salable item recommendations to a consumer based on search terms provided by a consumer.

For instance, in FIG. 25 a consumer searches for casual pants. The recommendation component 312c determines an identity of the consumer and matches the identity to recommended casual pants for the consumer. The recommendation component 312c operating in conjunction with the search server 308c selects one or more recommendations for casual pants and displays these recommendations within sections 2504 and 2506. For example, the search server 308c displays links to merchants that offer recommended salable pants within advertised search results section 2504. The search server 308c also displays an advertisement for one or more consumer specific recommended salable items within the advertisement section 2506. Similar to the merchant server 308b and the advertising server 308a, the search server 308c provides feedback to the recommendation server 302 responsive to a consumer selecting (and/or purchasing) any of the recommended salable items.

### Sharable Recommendation Embodiment

The example recommendation server 302 may also be configured to make available consumer recommendations to other people associated with the consumer. For instance, a consumer of interest may provide others (e.g., friends and family) with access to a read-only version of recommendations provided to the consumer. The read-only version may be available through a website hosted by the recommendation server 302. Alternatively, another consumer who has the recommendation application 307 may enter a name of the consumer of interest to view that consumer's recommended salable items. This enables a consumer of interest to provide family and friends with lists of recommended salable items rather than providing, for example, a birthday or Christmas list.

### Conclusion

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
determining salable items purchased by a consumer, the salable items each including a rating provided by the consumer;
determining cohort consumers from among a plurality of consumers by selecting consumers who have purchased at least some of the salable items and rated those salable items above a threshold;
determining recommendable salable items for different salable item categories by identifying salable items previously purchased by the cohort consumers in each salable item category; and
transmitting to the consumer device the salable item information associated with at least one of the recommendable salable items.

2. The method of claim 1, wherein the at least some of the salable items are associated with more than one salable item category and determining recommendable salable items includes determining a correlation between the more than one salable item category.

3. The method of claim 1, further comprising:
calculating a confidence factor based on at least one of i) a number of the cohort consumers that purchased the recommendable salable item, ii) a distance vector between each of the cohort consumers who purchased the recommendable salable item and the consumer, iii) how recently the cohort consumers purchased the recommendable salable item, and iv) a rating of the recommendable salable item provided by each of the cohort consumers; and
ranking the recommendable salable items based on the confidence factor.

4. The method of claim 3, wherein information associated with a predetermined number of recommendable salable items is transmitted to the consumer device, the information being organized such that information associated with higher ranked recommendable salable items is displayed before lower ranked recommendable salable items.

5. The method of claim 1, further comprising receiving from an application on the consumer device a recommendation request for salable items associated with the at least one salable item category.

6. The method of claim 1, wherein the salable items were purchased from a plurality of merchants.

7. An apparatus, comprising a recommendation engine configured to:
determine salable items purchased by a consumer, the salable items having been purchased from a plurality of merchants and from a plurality of salable item categories;
receive a rating from the consumer for each of the purchased salable items;
determine cohort consumers from among a plurality of consumers by selecting consumers who have purchased at least some of the salable items and rated those salable items similar to the ratings provided by the consumer;
determine salable items to recommend for each salable item category by determining recommendable salable items from direct matching based on other salable items associated with the same salable item category purchased by the cohort consumers;
rank the recommendable salable items for each of the salable item categories based on the direct matching; and
transmit information associated with a predetermined number of the recommendable salable items for at least one salable item category as recommended salable items based on the ranking

8. The apparatus of claim 7, wherein the recommendation engine is configured to:
determine salable items to recommend for each salable item category by determining the recommendable salable items from inferential matching based on correlations between different salable item categories for the other salable items purchased by the cohort consumers; and
rank the recommendable salable items for each of the salable item categories based the direct matching and the inferential matching.

9. The apparatus of claim 8, wherein the recommendation engine is configured to:
determine a confidence score for each of the recommendable salable items; and
rank the recommendable salable items based on the confidence score.

10. The apparatus of claim 9, wherein the confidence score is determined based on: i) a number of the cohort consumers that purchased the recommendable salable item, ii) a distance vector between each of the cohort consumers who purchased the recommendable salable item and the consumer, iii) a rating of the recommendable salable item provided by each of the cohort consumers, and iv) a degree of correlation between the salable item categories.

11. The apparatus of claim 7, wherein the recommendation engine is configured to:
receive from a third-party server a request message identifying a consumer and at least one salable item category;
filter the recommendable salable items based on salable items associated with the third- party server; and
transmit to the third-party server the information associated with a second predetermined number of the filtered salable items for the at least one requested salable item categories as recommended salable items for the consumer, causing the third-party server to display information associated with at least one of the transmitted salable items in conjunction with a webpage associated with the third-party server.

12. The apparatus of claim 11, wherein the third-party server includes a merchant server and the recommendation engine is configured to filter the recommendable salable items based on salable items sold by the merchant.

13. The apparatus of claim 11, wherein the third-party server includes an advertising server and the recommendation engine is configured to filter the recommendable salable items based on advertising space purchased from an advertiser associated with the advertising server.

14. The apparatus of claim 11, wherein the third-party server includes a search server and the recommendation engine is configured to filter the recommendable salable items based on a search term included within the request message.

15. The apparatus of claim 7, wherein the transmitted information includes at least one of a name of the recommended salable item, a price of the recommended salable item, a link to a merchant that offers the recommended salable item, and a description of the recommended salable item.

16. The apparatus of claim 7, further comprising a data collection component communicatively coupled to the recommendation engine, the data collection component being configured to determine salable items previously purchased by the consumer by accessing an account associated with the consumer, the account including at least one of an e-mail account, a credit card account, and a merchant account.

17. The apparatus of claim 7, wherein the recommendation engine is configured to:
determine at least one of a preference and a behavior of the consumer by determining purchasing trends within the purchase history of the consumer; and
determine salable items to recommend for each salable item category by determining recommendable salable items based on the at least one preference or behavior of the consumer.

18. A machine-accessible device having instructions stored thereon that are configured when executed to cause a machine to at least:
receive an indication that a salable item recommendation is to be transmitted to a consumer device, the salable item recommendation being for a first salable item category;
determine other salable items purchased by the consumer, the other salable items each including a rating previously provided by the consumer;
determine cohort consumers from among a plurality of consumers by selecting consumers who have purchased at least some of the other salable items and rated those other salable items similar to the ratings provided by the consumer, the other salable items including salable items from at least one of a second salable item category, at least some of the other salable items being purchased from different merchants;
determine recommendable salable items by:
(i) identifying salable items previously purchased by the cohort consumers that are associated with the salable item category, and
(ii) identifying purchased salable items positively recommended by the cohort consumers; and
transmit to the consumer device a data structure including at least one of the recommendable salable items.

19. The machine-accessible device of claim 18, further comprising instructions stored thereon that are configured when executed to cause the machine to:
receive a deal indication from a merchant that a first salable item is being offered at a discount for a predetermined period of time;
determine the first salable item is a recommendable salable item; and
transmit to the consumer device an indication that the first salable item is recommended and the discount provided by the merchant.

20. The machine-accessible device of claim 18, wherein the indication is a request from the consumer that includes at least one of a geographic location of the consumer, an advertised item type, a merchant name that provides the advertised item, an identifier associated with the advertised item.

21. The machine-accessible device of claim 18, further comprising instructions stored thereon that are configured when executed to cause the machine to:
determine a confidence score for each of the recommendable salable items; and
rank the recommendable salable items based on the confidence score,
wherein the confidence score is determined based on: i) a number of the cohort consumers that purchased the recommendable salable item, and iii) a rating of the recommendable salable item provided by each of the cohort consumers.
